(19) United States
(12) Patent Application Publication
(10) Pub. No.: US 2026/0292688 A1
(43) Pub. Date: Sep. 24, 2026

(54) SYSTEM AND METHOD FOR CONFIGURING UPLINK SIGNAL TRANSMISSION BY A MULTI-TRANSCEIVER DEVICE

(71) Applicant: QUALCOMM Incorporated, San Diego, CA (US)

(72) Inventors: Jung Ho RYU, Englewood Cliffs, NJ (US); Jelena DAMNJANOVIC, Del Mar, CA (US); Igor GUTMAN, Hod HaSharon (IL); Junyi LI, Greentown, PA (US); Tao LUO, San Diego, CA (US)

(21) Appl. No.: 19/085,657

(22) Filed: Mar. 20, 2025

(51) Int. Cl. H04W 52/02; H04W 72/21

(52) U.S. Cl. CPC H04W 52/0235; H04W 52/0216; H04W 72/21

(57) ABSTRACT

Various aspects of the present disclosure generally relate to wireless communication, and to supporting and configuring uplink (UL) transmissions for a multi-transceiver wireless device, such as a user equipment (UE). For example, a UE may include a primary transceiver and a low-power (LP) transceiver, and the UE may be configured to communicate via the primary transceiver when operating in an active mode and to communicate via the LP transceiver when operating in an LP mode. The UE may receive a configuration, via the transceiver and from a network node, that is associated with the LP transceiver and that indicates one or more transmit parameters associated with the LP transceiver. When operating in the LP mode, the UE may transmit, via the LP receiver, a UL transmission signal that is selected, in accordance with the transmit parameters, from one or more predefined transmission signals.

### FIELD OF THE DISCLOSURE

Aspects of the present disclosure relate generally to wireless communication systems, and more particularly, to a configuration of a multi-transceiver device for uplink signal transmission in wireless communication systems.

### BACKGROUND

Wireless communications systems are widely deployed to provide various types of services such as voice, video, packet data, messaging, broadcast, and other types of traffic. The services may include unicast, multicast, and/or broadcast services, among other examples. Typical wireless communication systems may support multiple-access radio access technologies and include a number of base stations or network nodes, each supporting communication for multiple communication devices, which may be otherwise known as user equipment (UE). These systems may be capable of supporting communication with multiple users by sharing available system resources (such as time domain resources, frequency domain resources, spatial domain resources, and device transmit power, among other examples). These systems may employ multiple-access technologies such as code division multiple access (CDMA) technology, time division multiple access (TDMA) technology, frequency division multiple access (FDMA) technology, orthogonal frequency division multiple access (OFDMA) technology, discrete Fourier transform spread orthogonal frequency division multiplexing (DFT-S-OFDM) technology, single-carrier frequency division multiple access (SC-FDMA) technology, and time division synchronous code division multiple access (TD-SCDMA) technology.

The above multiple-access technologies have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, carrier aggregation, high-precision positioning, and/or radio frequency (RF) sensing, among other examples. As the demand for mobile broadband access continues to increase, further improvements in NR may be implemented, and other radio access technologies, such as 6G, may be introduced to further advance mobile broadband evolution.

As wireless communication technology advances, wireless communication devices are expected to support increasingly complex applications and functionality. One challenge associated with supporting such advanced functionality is an increase in power consumption of wireless communication devices. Mobile devices, such as UEs, are typically powered by a battery or other limited power source to enable the device to be moved between locations without being connected to a fixed power source. Thus, if a mobile device executes an application that consumes a significant amount of power, the operational time of the mobile device before the battery is recharged is decreased, which can degrade user experience. As such, power consumption at mobile devices is typically an important design consideration in wireless communication systems. Some techniques to conserve power include configuring mobile devices to enter into low-power or sleep modes to conserve power during time periods of low activity. However, these low-power modes typically include deactivating communication circuitry, such as transceivers, to conserve power, which can delay the receipt or transmission of wireless communications by the mobile devices until a transition out of the low-power mode, which can increase latency in wireless communication systems.

### SUMMARY

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Some aspects described herein relate to a user equipment (UE) for wireless communication. The UE includes a processing system that includes one or more processors and one or more memories that store code and are coupled with the one or more processors. The processing system is configured to cause the UE to receive, from a network node via a primary transceiver, a configuration associated with a secondary transceiver. The configuration indicates one or more transmit parameters associated with the secondary transceiver and a wake-up signal (WUS) monitoring period. The processing system is also configured to cause the UE to transmit, via the secondary transceiver, to the network node and during the WUS monitoring period, an uplink (UL) transmission signal selected, in accordance with the one or more transmit parameters, from one or more predefined transmission signals.

Some aspects described herein relate to a method of wireless communication performed by a UE. The method includes receiving, from a network node via a primary transceiver, a configuration associated with a secondary transceiver. The configuration indicates one or more transmit parameters associated with the secondary transceiver and a WUS monitoring period. The method also includes transmitting, via the secondary transceiver, to the network node and during the WUS monitoring period, a UL transmission signal selected, in accordance with the one or more transmit parameters, from one or more predefined transmission signals.

Some aspects described herein relate to an apparatus. The apparatus includes means for receiving, from a network node via a primary transceiver, configuration associated with a secondary transceiver. The configuration indicates one or more transmit parameters associated with the secondary transceiver and a WUS monitoring period. The apparatus also includes means for transmitting, via the secondary transceiver, to the network node and during the WUS monitoring period, a UL transmission signal selected, in accordance with the one or more transmit parameters, from one or more predefined transmission signals.

Some aspects described herein relate to a non-transitory computer-readable medium that stores code that, when executed by one or more processors, cause the one or more processors to perform operations. The operations include receiving, from a network node via a primary transceiver, a configuration associated with a secondary transceiver. The configuration indicates one or more transmit parameters associated with the secondary transceiver and a WUS monitoring period. The operations also include transmitting, via the secondary transceiver, to the network node and during the WUS monitoring period, a UL transmission signal selected, in accordance with the one or more transmit parameters, from one or more predefined transmission signals.

Some aspects described herein relate to a network node for wireless communication. The network node includes a processing system that includes one or more processors and one or more memories that store code and are coupled with the one or more processors. The processing system is configured to cause the network node to transmit, to a UE that includes a primary transceiver and a secondary transceiver, a configuration associated with the secondary transceiver of the UE. The configuration indicates one or more transmit parameters associated with the secondary transceiver and a WUS monitoring period. The processing system is also configured to cause the network node to receive, from the UE and during the WUS monitoring period, a UL transmission signal in accordance with the one or more transmit parameters. The UL transmission signal is included in one or more predefined transmission signals.

Some aspects described herein relate to a method of wireless communication performed by a network node. The method includes transmitting, to a UE that includes a primary transceiver and a secondary transceiver, a configuration associated with the secondary transceiver of the UE. The configuration indicates one or more transmit parameters associated with the secondary transceiver and a WUS monitoring period. The method also includes receiving, from the UE and during the WUS monitoring period, a UL transmission signal in accordance with the one or more transmit parameters. The UL transmission signal is included in one or more predefined transmission signals.

Some aspects described herein relate to an apparatus. The apparatus includes means for transmitting, to a UE that includes a primary transceiver and a secondary transceiver, a configuration associated with the secondary transceiver of the UE. The configuration indicates one or more transmit parameters associated with the secondary transceiver and a WUS monitoring period. The apparatus also includes means for receiving, from the UE and during the WUS monitoring period, a UL transmission signal in accordance with the one or more transmit parameters. The UL transmission signal is included in one or more predefined transmission signals.

Some aspects described herein relate to a non-transitory computer-readable medium that stores code that, when executed by one or more processors, cause the one or more processors to perform operations. The operations include transmitting, to a UE that includes a primary transceiver and a secondary transceiver, a configuration associated with the secondary transceiver of the UE. The configuration indicates one or more transmit parameters associated with the secondary transceiver and a WUS monitoring period. The operations also include receiving, from the UE and during the WUS monitoring period, a UL transmission signal in accordance with the one or more transmit parameters. The UL transmission signal is included in one or more predefined transmission signals.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

Other aspects, features, and implementations of the present disclosure will become apparent to a person having ordinary skill in the art, upon reviewing the following description of specific, example implementations of the present disclosure in conjunction with the accompanying figures. While features of the present disclosure may be described relative to particular implementations and figures below, all implementations of the present disclosure can include one or more of the advantageous features described herein. In other words, while one or more implementations may be described as having particular advantageous features, one or more of such features may also be used in accordance with the various implementations of the disclosure described herein. In similar fashion, while example implementations may be described below as device, system, or method implementations, such example implementations can be implemented in various devices, systems, methods, and computer-readable media.

### BRIEF DESCRIPTION OF THE DRAWINGS

A further understanding of the nature and advantages of the present disclosure may be realized by reference to the following drawings. In the appended figures, similar components or features may have the same reference label and designations. Further, various components of the same type may be distinguished by following the reference label by a dash and a second label that distinguishes among the similar components, or by following the reference label with a letter. If just the first reference label is used in the specification, the description is applicable to any one of the similar components having the same first reference label irrespective of the second reference label or letter.

FIG. 1 is a block diagram illustrating details of an example wireless communication network in accordance with the present disclosure.

FIG. 2 is a block diagram illustrating examples of a network node and a user equipment (UE) in accordance with the present disclosure.

FIG. 3 is a block diagram illustrating an example disaggregated base station architecture in accordance with the present disclosure.

FIG. 4 is a block diagram illustrating an example of a wireless communication system that supports configuring uplink (UL) signal transmission by a multi-transceiver UE in accordance with the present disclosure.

FIG. 5 is a flow diagram illustrating an example of a process that supports UL signal configuration and transmission by the multi-transceiver UE of FIG. 4 in accordance with the present disclosure.

FIG. 6 is a block diagram illustrating an example of a multi-transceiver UE that supports UL signal transmission in accordance with the present disclosure.

FIG. 7 is a block diagram illustrating an example of a UE capability message in accordance with the present disclosure.

FIG. 8 is a block diagram illustrating an example of a configuration associated with a low power (LP) transceiver in accordance with the present disclosure.

FIG. 9 is a diagram illustrating an example of selecting predetermined transmission signal samples for use in generating a UL transmission by a multi-transceiver UE in accordance with the present disclosure.

FIG. 10 is a ladder diagram of an example of operations that support transmission of a CSI report message by a multi-transceiver UE in accordance with the present disclosure.

FIG. 11 is a ladder diagram of an example of operations that support transmission of an LP scheduling request message by a multi-transceiver UE in accordance with the present disclosure.

FIG. 12 is a ladder diagram of another example of operations that support transmission of an LP scheduling request message by a multi-transceiver UE in accordance with the present disclosure.

FIG. 13 is a flow diagram illustrating an example process that supports UL signal transmission by a multi-transceiver device in accordance with the present disclosure.

FIG. 14 is a block diagram of an example UE that supports UL signal transmission by a multi-transceiver device in accordance with the present disclosure.

FIG. 15 is a flow diagram illustrating an example process that supports configuring UL signal transmission for a multi-transceiver device in accordance with the present disclosure.

FIG. 16 is a block diagram of an example network node that supports configuring UL signal transmission for a multi-transceiver device in accordance with the present disclosure.

### DETAILED DESCRIPTION

Various aspects of the disclosure are described more fully hereinafter with reference to the accompanying drawings. This disclosure may, however, be embodied in many different forms and is not to be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

The present disclosure provides systems, apparatus, methods, and computer-readable media for configuring uplink (UL) transmissions for multi-transceiver devices of wireless communication systems. Some aspects more specifically relate to configuring a user equipment (UE) that includes a primary (or “main”) transceiver as well as a low-power (LP) transceiver to perform UL signal transmissions while the UE is operating in an LP mode in which the primary transceiver is deactivated and the LP transceiver is active or powered on. As used herein, an “LP transceiver” refers to a transceiver that is capable of processing and communicating a limited number of signals, typically within a limited bandwidth, such that the LP transceiver has a lower power consumption rate than the primary transceiver. To configure the UE to transmit one or more types of UL transmission signals during one or more upcoming wake-up signal (WUS) monitoring periods, a network node may transmit a configuration to the UE while the UE is in a normal operating mode, which may also be referred to as an active mode, during which the UE uses its primary transceiver for communication. The UE receives the configuration using the primary transceiver and identifies one or more transmit parameters indicated by the configuration, where the transmit parameters are associated with the secondary transceiver and a particular WUS monitoring period. During the WUS monitoring period, the UE operates in the LP mode in which the primary transceiver is powered down, and the UE transmits a UL reference signal via the LP transceiver to the network node. The UE selects the UL reference signal, from one or more predefined transmission signals, in accordance with the transmit parameters indicated by the configuration. For example, the predefined transmission signals may include or correspond to relatively less complex signals that are capable of being transmitted by the LP transceiver and that are associated with one or more parameters that vary between at least some of the predefined transmission signals. The UE may select the appropriate predefined transmission signal in accordance with an association or mapping, indicated by the configuration, between one or more transmit parameter values and parameter values or UL data to be indicated by the UL transmission signal.

Multi-transceiver devices described herein, such as the UE, may be capable of supporting various types of UL signaling while operating in the LP mode, and each of the types of signaling may be configured by the network node through the selection of the transmit parameters indicated by the configuration. In some examples, the UL transmission signal sent by the UE via the LP transceiver includes a UL reference signal, such as a sounding reference signal (SRS). As another example, the UL transmission signal can include an LP scheduling request that indicates a request by the UE for the network node to send a WUS and, once the UE transitions to the normal operating mode, provide a UL grant to enable the UE to send an UL signal via the primary transceiver. In some other examples, the UL transmission signal may include or represent a channel state information (CSI) report message. However, unlike a typical CSI report message that can be sent by the primary transceiver, the UE may be configured to send an LP CSI report message via the LP transceiver that includes only a limited subset of CSI measurements that are capable of being measured using the LP transceiver. As an example, the LP CSI report message may include an indicator associated with a CSI reference signal (CSI-RS) or a synchronization signal block (SSB) that is measured by the UE using the LP transceiver. The LP CSI report message may also include a reference signal received power (RSRP) value or range that is associated with the indicated CSI-RS or SSB.

Particular implementations of the subject matter described in this disclosure can be implemented to realize one or more of the following potential advantages. In some aspects, the present disclosure provides techniques for configuring UL signal transmissions that reduce power consumption at multi-transceiver devices. For example, by configuring a multi-transceiver device, such as a UE, to transmit particular types of UL transmission signals using an LP transceiver, the multi-transceiver device can operate in an LP mode associated with a reduced rate of power consumption and still be capable of transmitting UL transmission signals, instead of transitioning to an active mode that is associated with a larger rate of power consumption to transmit the UL transmission signals. Instead of transitioning to the active mode, the UE may transmit a UL transmission signal via the LP transceiver while remaining in the LP mode, either until an instruction from the network node or an end of a WUS monitoring period, which decreases the power consumption of the UE as compared to transitioning to the active mode for each UL signal transmission. Additionally, enabling the UE to transmit the UL transmission signal can provide the network node with information to enable additional functionality or to improve communications within the wireless network without waiting until an end of the WUS monitoring period. For example, by transmitting a UL transmission signal that indicates a CSI report message or a UL reference signal, the UE may provide or enable the determination of channel measurements that can be used by the network node to adjust downlink transmit parameters such as a modulation and coding scheme (MCS) or a selected transmit beam. Adjusting such DL transmit parameters while the UE is operating in the LP mode can improve wireless communications between the UE and the network node while the UE is operating in the LP mode.

This disclosure relates generally to providing or participating in authorized shared access between two or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, long term evolution (LTE) networks, Global System for Mobile Communications (GSM) networks, 5th Generation (5G) or new radio (NR) networks (sometimes referred to as “5G NR” networks, systems, or devices), as well as other communications networks. As described herein, the terms “networks” and “systems” may be used interchangeably.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV). 5G NR networks contemplate diverse deployments, diverse spectrum, and diverse services and devices that may be implemented using an OFDM-based unified, air interface. 5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 gigahertz (GHz) FDD or TDD implementations, subcarrier spacing may occur with 15 kilohertz (kHz), for example over 1, 5, 10, 20 megahertz (MHz), and the like bandwidth. For other various outdoor and small cell coverage deployments of TDD greater than 3 GHz, subcarrier spacing may occur with 30 kHz over 80 or 100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases. For clarity, certain aspects of the present disclosure may be described below with reference to example 5G NR implementations or in a 5G-centric way, and 5G terminology may be used as illustrative examples in portions of the description below; however, the description is not intended to be limited to 5G applications.

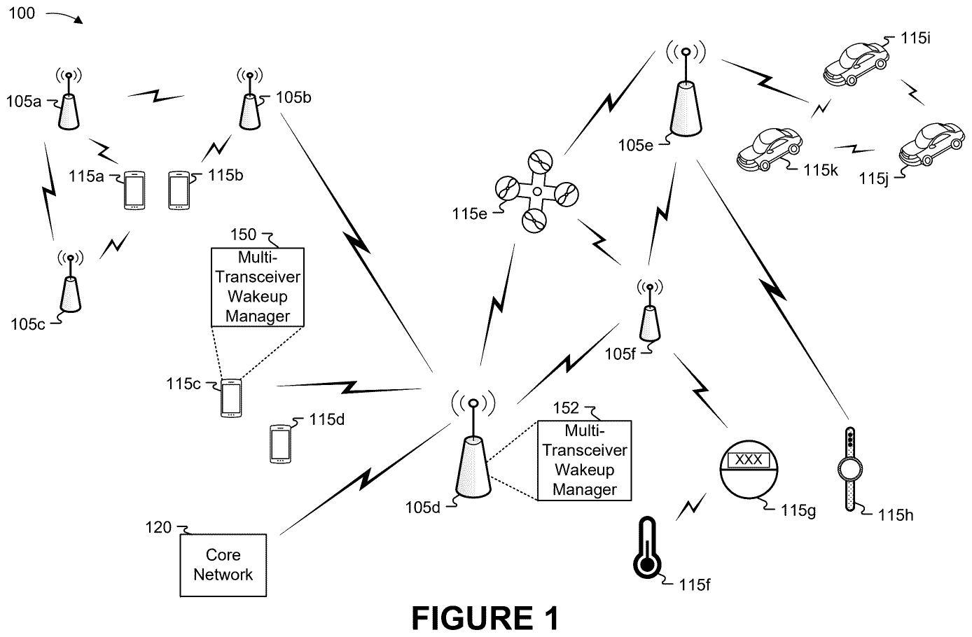

FIG. 1 is a block diagram illustrating details of an example wireless communication network 100 in accordance with the present disclosure. The wireless communication network 100 may, for example, be or include elements of a 5G (or NR) network or a 6G network, among other examples. As appreciated by those skilled in the art, components appearing in FIG. 1 are likely to have related counterparts in other network arrangements including, for example, cellular-style network arrangements and non-cellular-style-network arrangements, such as device-to-device, peer-to-peer, or ad hoc network arrangements, among other examples.

The wireless communication network 100 illustrated in FIG. 1 includes multiple network nodes 105, also referred to as network entities, and multiple user equipments (UEs) 115. A network node may be a station that communicates with UEs and may be referred to as a base station, an evolved node B (eNB), a next generation eNB (gNB), an access point, and the like. Each network node 105 may provide communication coverage for a particular geographic area. In 3GPP, the term “cell” can refer to this particular geographic coverage area of a network node or a network node subsystem serving the coverage area, depending on the context in which the term is used. In implementations of the wireless communication network 100 herein, the network nodes 105 may be associated with a same operator or different operators, such as the wireless communication network 100 may include a plurality of operator wireless networks. In some examples, an individual network node 105 or UE 115 may be operated by more than one network operating entity. In some other examples, each network node 105 and UE 115 may be operated by a single network operating entity.

The network nodes 105 and the UEs 115 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR 4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, in accordance with user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 105 may include one or more devices, components, or systems that enable communication between a UE 115 and one or more devices, components, or systems of the wireless communication network 100. A network node 105 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 105 may be implemented as a single physical node (for example, a single physical structure) or may be implemented as two or more physical nodes (for example, two or more distinct physical structures). For example, a network node 105 may be a device or system that implements part of a radio protocol stack, a device or system that implements a full radio protocol stack (such as a full gNB protocol stack), or a collection of devices or systems that collectively implement the full radio protocol stack. For example, and as shown, a network node 105 may be an aggregated network node (having an aggregated architecture), meaning that the network node 105 may implement a full radio protocol stack that is physically and logically integrated within a single node (for example, a single physical structure) in the wireless communication network 100. For example, an aggregated network node 105 may consist of a single standalone base station or a single TRP that uses a full radio protocol stack to enable or facilitate communication between a UE 115 and a core network 120 of the wireless communication network 100.

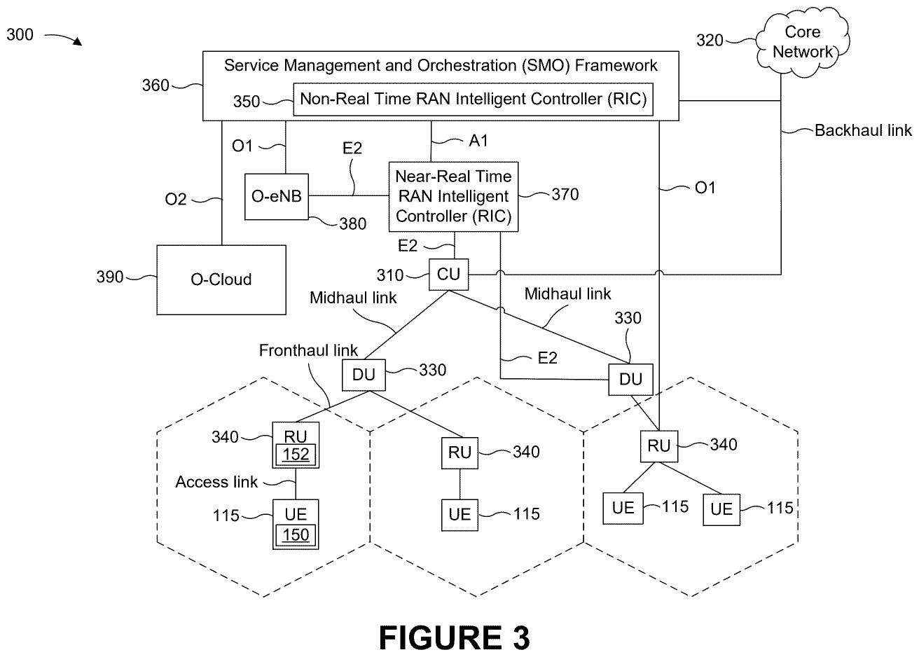

Alternatively, a network node 105 may be a disaggregated network node (sometimes referred to as a disaggregated base station), meaning that the network node 105 may implement a radio protocol stack that is physically distributed and/or logically distributed among two or more nodes in the same geographic location or in different geographic locations. For example, a disaggregated network node may have a disaggregated architecture, as further described herein with reference to FIG. 3. In some deployments, disaggregated network nodes 105 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 105 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 115, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 115.

In some aspects, a single network node 105 may include a combination of one or more CUs, one or more DUs, and/or one or more RUs. Additionally, or alternatively, a network node 105 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 105 (for example, a base station, an RU, or a TRP) may provide communication coverage for a particular geographic area. In the 3GPP, the term “cell” can refer to a coverage area of a network node 105 or to a network node 105 itself, depending on the context in which the term is used. A network node 105 may support one or multiple (for example, three) cells. In some examples, a network node 105 may provide communication coverage for a macro cell, a pico cell, a femto cell, or another type of cell. A macro cell may cover a relatively large geographic area (for example, several kilometers in radius) and may allow unrestricted access by UEs 115 with service subscriptions. A pico cell may cover a relatively small geographic area and may allow unrestricted access by UEs 115 with service subscriptions. A femto cell may cover a relatively small geographic area (for example, a home) and may allow restricted access by UEs 115 having association with the femto cell (for example, UEs 115 in a closed subscriber group (CSG)). A network node 105 for a macro cell may be referred to as a macro network node. A network node 105 for a pico cell may be referred to as a pico network node. A network node 105 for a femto cell may be referred to as a femto network node or an in-home network node. In some examples, a cell may not necessarily be stationary. For example, the geographic area of the cell may move according to the location of an associated mobile network node 105 (for example, a train, a satellite base station, an unmanned aerial vehicle, or an NTN network node).

The wireless communication network 100 may be a heterogeneous network that includes network nodes 105 of different types, such as macro network nodes, pico network nodes, femto network nodes, relay network nodes, aggregated network nodes, and/or disaggregated network nodes, among other examples. In the example shown in FIG. 1, network nodes 105d and 105e are regular macro network nodes, while network nodes 105 a-105c are macro network nodes enabled with one of 3 dimension (3D), full dimension (FD), or massive MIMO. Network nodes 105a-105c take advantage of their higher dimension MIMO capabilities to exploit 3D beamforming in both elevation and azimuth beamforming to increase coverage and capacity. Network node 105f is a small cell network node which may be a home node or portable access point. A network node may support one or multiple cells, such as two cells, three cells, four cells, and the like. Various different types of network nodes 105 may generally transmit at different power levels, serve different coverage areas, and/or have different impacts on interference in the wireless communication network 100 than other types of network nodes 105. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 105 may be, may include, or may operate as an RU, a TRP, or a base station that communicates with one or more UEs 115 via a radio access link (which may be referred to as a “Uu” link). The radio access link may include a downlink and an uplink. “Downlink” (or “DL”) refers to a communication direction from a network node 105 to a UE 115, and “uplink” (or “UL”) refers to a communication direction from a UE 115 to a network node 105. Downlink channels may include one or more control channels and one or more data channels. A downlink control channel may be used to transmit downlink control information (DCI) (for example, scheduling information, reference signals, and/or configuration information) from a network node 105 to a UE 115. A downlink data channel may be used to transmit downlink data (for example, user data associated with a UE 115) from a network node 105 to a UE 115. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 115 to a network node 105. An uplink data channel may be used to transmit uplink data (for example, user data associated with a UE 115) from a UE 115 to a network node 105. Uplink control channels may include one or more physical uplink control channels (PUCCHs), and uplink data channels may include one or more physical uplink shared channels (PUSCHs). The downlink and the uplink may each include a set of resources on which the network node 105 and the UE 115 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 115. A UE 115 may be configured with both an uplink BWP and a downlink BWP (where the uplink BWP and the downlink BWP may be the same BWP or different BWPs). A BWP may be dynamically configured (for example, by a network node 105 transmitting a DCI configuration to the one or more UEs 115) and/or reconfigured, which means that a BWP can be adjusted in real-time (or near-real-time) in accordance with changing network conditions in the wireless communication network 100 and/or in accordance with the specific requirements of the one or more UEs 115. This enables more efficient use of the available frequency domain resources in the wireless communication network 100 because fewer frequency domain resources may be allocated to a BWP for a UE 115 (which may reduce the quantity of frequency domain resources that a UE 115 is required to monitor), leaving more frequency domain resources to be spread across multiple UEs 115. Thus, BWPs may also assist in the implementation of lower-capability UEs 115 by facilitating the configuration of smaller bandwidths for communication by such UEs 115.

As described above, in some aspects, the wireless communication network 100 may be, may include, or may be included in, an IAB network. In an IAB network, at least one network node 105 is an anchor network node that communicates with the core network 120. An anchor network node 105 may also be referred to as an IAB donor (or “IAB-donor”). The anchor network node 105 may connect to the core network 120 via a wired backhaul link. For example, an Ng interface of the anchor network node 105 may terminate at the core network 120. Additionally, or alternatively, an anchor network node 105 may connect to one or more devices of the core network 120 that provide a core access and mobility management function (AMF). An IAB network also generally includes multiple non-anchor network nodes 105, which may also be referred to as relay network nodes or simply as IAB nodes (or “IAB-nodes”). Each non-anchor network node 105 may communicate directly with the anchor network node 105 via a wireless backhaul link to access the core network 120, or may communicate indirectly with the anchor network node 105 via one or more other non-anchor network nodes 105 and associated wireless backhaul links that form a backhaul path to the core network 120. Some anchor network nodes 105 or other non-anchor network nodes 105 may also communicate directly with one or more UEs 115 via wireless access links that carry access traffic. In some examples, network resources for wireless communication (such as time resources, frequency resources, and/or spatial resources) may be shared between access links and backhaul links.

The wireless communication network 100 may support synchronous or asynchronous operation. For synchronous operation, the network nodes may have similar frame timing, and transmissions from different network nodes may be approximately aligned in time. For asynchronous operation, the network nodes may have different frame timing, and transmissions from different network nodes may not be aligned in time. In some scenarios, networks may be enabled or configured to handle dynamic switching between synchronous or asynchronous operations.

The UEs 115 are physically dispersed throughout the wireless communication network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. Within the present document, a “mobile” apparatus or UE need not necessarily have a capability to move, and may be stationary. Some non-limiting examples of a mobile apparatus, such as may include implementations of one or more of the UEs 115, include a mobile phone, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A UE 115 may additionally be an “Internet of Things” (IoT) or “Internet of Everything” (IoE) device, an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, a gesture tracking device, a medical device, a digital audio player (such as MP3 player), a camera or a game console, among other examples. The UEs 115 may also include digital home or smart home devices, such as a home audio, video, and multimedia device, an appliance, a sensor, a vending machine, intelligent lighting, a home security system, or a smart meter, among other examples. In one aspect, a UE may be a device that includes a Universal Integrated Circuit Card (UICC). In another aspect, a UE may be a device that does not include a UICC. In some aspects, UEs that do not include UICCs may be referred to as IoE devices. The UEs 115a-115d of the implementation illustrated in FIG. 1 are examples of mobile smart phone-type devices accessing the wireless communication network 100. A UE may be a machine specifically configured for connected communication, including machine type communication (MTC), enhanced MTC (eMTC), narrowband IoT (NB-IoT) and the like. The UEs 115e-115k illustrated in FIG. 1 are examples of various machines configured for communication that access the wireless communication network 100.

A mobile apparatus, such as the UEs 115, may be able to communicate with any type of the network nodes, whether macro network nodes, pico network nodes, femto network nodes, macro base stations, pico base stations, femto base stations, relays, and the like. In FIG. 1, a communication link (represented as a lightning bolt) indicates wireless transmissions between a UE and a serving network node, which is a network node designated to serve the UE on the downlink or uplink, wireless transmissions between network nodes, and backhaul transmissions between network nodes. Backhaul communication between network nodes of the wireless communication network 100 may occur using wired or wireless communication links.

In some examples, two or more UEs 115 (for example, shown as UE 115i and UE 115j) may communicate directly with one another using sidelink communications (for example, without communicating by way of a network node 105 as an intermediary). As an example, the UE 115i may directly transmit data, control information, or other signaling as a sidelink communication to the UE 115j. This is in contrast to, for example, the UE 115i first transmitting data in an UL communication to a network node 105, which then transmits the data to the UE 115j in a DL communication. In various examples, the UEs 115 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 105 may schedule and/or allocate resources for sidelink communications between UEs 115 in the wireless communication network 100. In some other deployments and configurations, a UE 115 (instead of a network node 105) may perform, or collaborate or negotiate with one or more other UEs to perform, scheduling operations, resource selection operations, and/or other operations for sidelink communications.

In some examples, the UEs 115 and the network nodes 105 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

As an example of operation at the wireless communication network 100, the network nodes 105a-105c serve the UEs 115a and 115b using 3D beamforming and coordinated spatial techniques, such as coordinated multipoint (CoMP) or multi-connectivity. Macro network node 105d performs backhaul communications with the network nodes 105a-105c, as well as with the small cell network node 105f. Macro network node 105d also transmits multicast services which are subscribed to and received by the UEs 115c and 115d. Such multicast services may include mobile television or streaming video, or may include other services for providing community information, such as weather emergencies or alerts, such as Amber alerts or gray alerts.

The wireless communication network 100 of implementations supports mission critical communications with ultra-reliable and redundant links for mission critical devices, such the UE 115e, which is a drone. Redundant communication links with the UE 115e include communication links from the macro network nodes 105d and 105e, as well as the small cell network node 105f. Other machine type devices, such as UE 115f (thermometer), the UE 115g (smart meter), and the UE 115h (wearable device) may communicate through the wireless communication network 100 either directly with network nodes, such as the small cell network node 105f and the macro network node 105e, or in multi-hop configurations by communicating with another user device which relays its information to the network, such as the UE 115f communicating temperature measurement information to the UE 115g, which is then reported to the network through the small cell network node 105f. The wireless communication network 100 may provide additional network efficiency through dynamic, low-latency TDD or FDD communications, such as in a vehicle-to-vehicle (V2V) mesh network between the UEs 115i-115k communicating with the macro network node 105e.

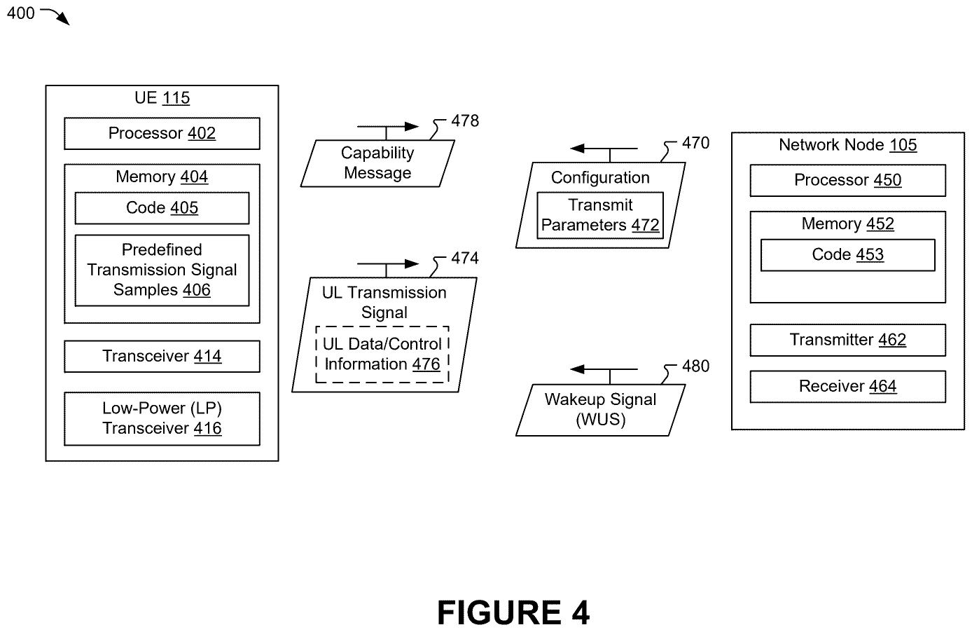

In some aspects, one or more of the network nodes 105 and one or more of the UEs 115 may perform wireless communications that support configuring UL signal transmission for a multi-transceiver device. For example, one or more of the UEs 115 (such as the UE 115c) may include a multi-transceiver wakeup manager 150 that manages operations that support UL signal transmission by a multi-transceiver device. The operations may include receiving a configuration via a primary transceiver, and transmitting, via a secondary transceiver and during a WUS monitoring period, a UL transmission signal that is selected in accordance with one or more transmit parameters indicated by the configuration, as further described herein with reference to FIG. 4. As another example, one or more of the network nodes 105 (such as the network node 105d) may include a multi-transceiver wakeup manager 152 that manages operations that support configuring UL signal transmission for a multi-transceiver device. The operations may include transmitting a configuration that indicates one or more transmit parameters, and receiving, during a WUS monitoring period, a UL transmission signal in accordance with the one or more transmit parameters, as further described herein with reference to FIG. 4.

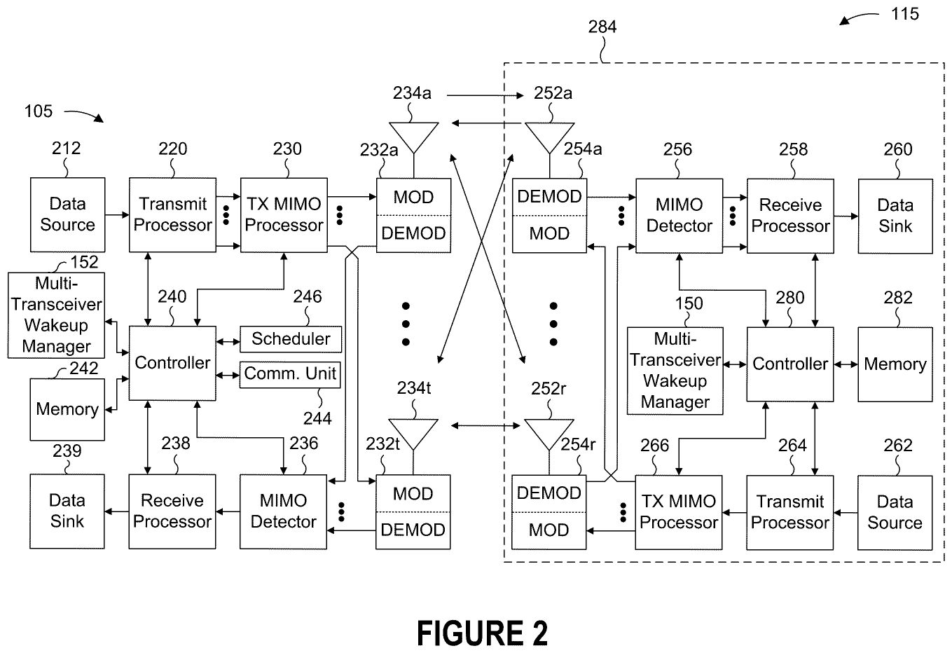

FIG. 2 is a block diagram illustrating examples of a network node 105 and a UE 115 in accordance with the present disclosure. The network node 105 and the UE 115 may be one of the network nodes 105 and one of the UEs 115 in FIG. 1. For a restricted association scenario, the network node 105 may be the small cell network node 105f in FIG. 1, and the UE 115 may be the UE 115c or 115d operating in a service area of the network node 105f, which in order to access the small cell network node 105f, would be included in a list of accessible UEs for the small cell network node 105f. Additionally, the network node 105 may be a base station or network entity of some other type. As shown in FIG. 2, the network node 105 may be equipped with antennas 234a through 234t, and the UE 115 may be equipped with antennas 252a through 252r for facilitating wireless communications.

For downlink communication from the network node 105 to the UE 115, a transmit processor 220 may receive data (“downlink data”) from a data source 212 (such as a data pipeline or a data queue) and control information from a controller 240. The control information may be for the physical broadcast channel (PBCH), physical control format indicator channel (PCFICH), physical hybrid-ARQ (automatic repeat request) indicator channel (PHICH), PDCCH, enhanced physical downlink control channel (EPDCCH), or MTC physical downlink control channel (MPDCCH), among other examples. The data may be for the PDSCH, among other examples. The transmit processor 220 may process, such as encode and symbol map, such as in accordance with a selected modulation and coding scheme (MCS), the data and control information to obtain data symbols and control symbols, respectively. Additionally, the transmit processor 220 may generate reference symbols for reference signals, such as for a cell-specific reference signal (CRS), a demodulation reference signal (DMRS), or a channel state information (CSI) reference signal (CSI-RS) and/or synchronization signals, such as for a primary synchronization signal (PSS) or a secondary synchronization signal (SSS).

Transmit (TX) multiple-input multiple-output (MIMO) processor 230 may perform spatial processing on the data symbols, the control symbols, and/or the reference symbols, if applicable, and may provide output symbol streams to modems 232a through 232t. For example, each output symbol stream may be provided to a respective modulator component (shown as MOD) of a modem 232. In some examples, spatial processing performed on the data symbols, the control symbols, and/or the reference symbols may include precoding. Each modem 232 may use the respective modulator component to process a respective output symbol stream, such as for OFDM, among other examples, to obtain an output sample stream. Each modem 232 may additionally, or alternatively use the respective modulator component to process the output sample stream to obtain a downlink signal. For example, to process the output sample stream, each modem 232 may use the respective modulator component to convert to analog, amplify, filter, and upconvert the output sample stream to obtain the downlink signal. The modems 232a through 232t may together transmit a set of downlink signals from via the antennas 234a through 234t, respectively.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

At the UE 115, the antennas 252a through 252r may receive the downlink signals from the network node 105 and may provide a set of received signals to modems 254a through 254r. For example, each received signal may be provided to a respective demodulator component (shown as DEMOD) of a modem 254. Each modem 254 may use the respective demodulator component to condition a respective received signal to obtain input samples. For example, to condition the respective received signal, the demodulator component of each modem 254 may filter, amplify, downconvert, and/or digitize the respective received signal to obtain the input samples. Each modem 254 may use the respective demodulator component to further process the input samples, such as for OFDM, among other examples, to obtain received symbols. MIMO detector 256 may obtain received symbols from modems 254a through 254r, perform MIMO detection on the received symbols if applicable, and provide detected symbols. Receive processor 258 may process the detected symbols, provide decoded data for the UE 115 to a data sink 260 (which may include a data pipeline, a data queue, and/or an application executed on the UE 115), and provide decoded control information to a controller 280. For example, to process the detected symbols, the receive processor 258 may demodulate, deinterleave, and decode the detected symbols.

In some aspects, one or a combination of the antenna(s) 252, the modem(s) 254, the MIMO detector 256, the receive processor 258, the transmit processor 264, or the TX MIMO processor 266 may be included in a transceiver that is included in the UE 115. The transceiver may be under control of and used by one or more processors, such as the controller 280, and in some aspects in conjunction with processor-readable code stored in the memory 282, to perform aspects of the methods, processes, or operations described herein. In some aspects, the UE 115 may include another interface, another communication component, and/or another component that facilitates communication with the network node 105 and/or another UE 115. Additionally, or alternatively, one or more of the components of the UE 115 may be included in a housing 284.

For uplink communications from the UE 115 to the network node 105, a transmit processor 264 may receive and process data (“uplink data”) from a data source 262 and control information (such as for the PUCCH) from the controller 280. The control information may include one or more parameters, feedback, one or more signal measurements, and/or other types of control information. In some aspects, the receive processor 258 and/or the controller 280 may determine, for a received signal (such as received from the network node 105 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a channel quality indicator (CQI) parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 115 by the network node 105.

The transmit processor 264 may generate reference symbols for a reference signal, such as an uplink DMRS, an uplink sounding reference signal (SRS), and/or another type of reference signal. The symbols from the transmit processor 264 may be precoded by a TX MIMO processor 266, if applicable, and further processed by the modems 254a through 254r (such as for DFT-s-OFDM or CP-OFDM, among other examples). The TX MIMO processor 266 may perform spatial processing (for example, precoding) on the data symbols, the control symbols, and/or the reference symbols, if applicable, and may provide a set of output symbol streams to the modems 254. For example, each output symbol stream may be provided to a respective modulator component (shown as MOD) of a modem 254. Each modem 254 may use the respective modulator component to process a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254r may transmit a set of uplink signals via the corresponding antennas 252a through 252r, respectively. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 115) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

At network node 105, the uplink signals from the UE 115 may be received by antennas 234a through 234t, processed by demodulator components of the modems 232a through 232t, detected by a MIMO detector 236 if applicable, and further processed by a receive processor 238 to obtain decoded data and/or control information sent by the UE 115. The receive processor 238 may provide the decoded data to a data sink 239 (which may be a data pipeline, a data queue, and/or another type of data sink) and provide the decoded control information to the controller 240.

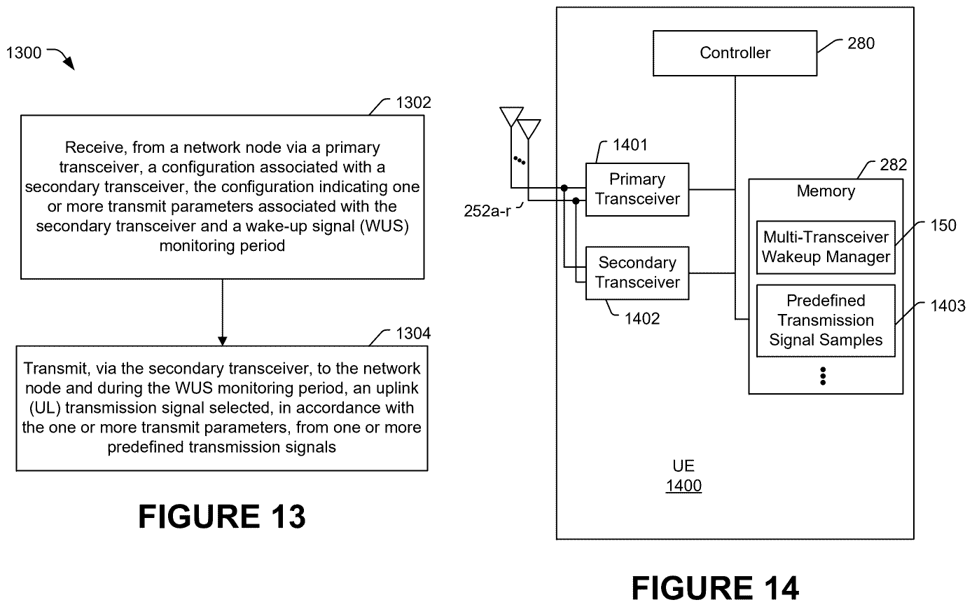

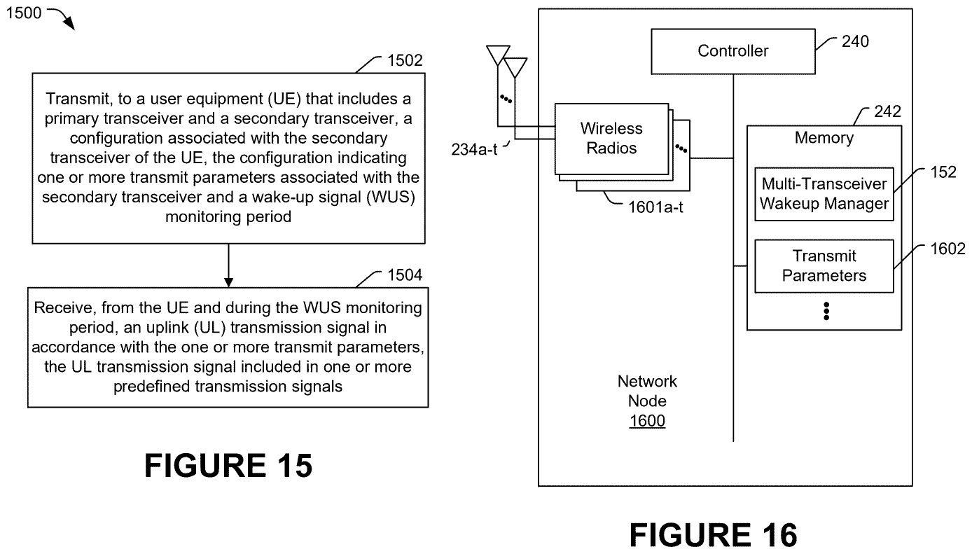

The controllers 240 and 280 may direct the operation at the network node 105 and the UE 115, respectively. The controller 240 (or other processors and modules at the network node 105) may perform or direct the execution of various processes for the techniques described herein, such as to perform or direct the execution illustrated in FIG. 15, or other processes for the techniques described herein. Similarly, the controller 280 (or other processors and modules at the UE 115) may perform or direct the execution of various processes for the techniques described herein, such as to perform or direct the execution illustrated in FIG. 13, or other processes for the techniques described herein. For example, the controller 240 and/or the controller 280 may perform or control operations that support configuring UL signal transmission for a multi-transceiver device. Additionally, or alternatively, the UE 115 may include the multi-transceiver wakeup manager 150 and the network node 105 may include the multi-transceiver wakeup manager 152 that are configured to manage operations to support UL signal transmission by a multi-transceiver device, as further described herein.

Although referred to as “controllers”, the controllers 240 and 280 may include one or more processors and/or one or more controllers, and also or in the alternative be referred to as “processors” or “controller/processors”. In some aspects, a single processor may perform all of the operations described as being performed by the one or more processors or the one or more controllers. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors.

The memories 242 and 282 may store data and program codes for the network node 105 and the UE 115, respectively. Reference to “one or more memories” should be understood to refer to any one or more memories of a corresponding device, such as the memory described in connection with FIG. 2. For example, an operation described as being performed by one or more memories can be performed by the same subset of the one or more memories or different subsets of the one or more memories.

The network node 105 may use a scheduler 246 to schedule one or more UEs 115 for downlink or uplink communications. In some aspects, the scheduler 246 may use DCI to dynamically schedule DL transmissions to the UE 115 and/or UL transmissions from the UE 115. In some examples, the scheduler 246 may allocate recurring time domain resources and/or frequency domain resources that the UE 115 may use to transmit and/or receive communications using an RRC configuration (for example, a semi-static configuration), for example, to perform semi-persistent scheduling (SPS) or to configure a configured grant (CG) for the UE 115.

In some examples, the network node 105 may use a communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 105 may use the communication unit 244 to transmit and/or receive data associated with the UE 115 or to perform network control signaling, among other examples. The communication unit 244 may include a transceiver and/or an interface, such as a network interface.

One or more antennas of the antennas 252 or the antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 115 or network nodes 105 may include different numbers of antenna elements. For example, a UE 115 may include a single antenna element, two antenna elements, four antenna elements, eight antenna elements, or a different number of antenna elements. As another example, a network node 105 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

FIG. 3 is a block diagram illustrating an example disaggregated base station architecture 300 in accordance with the present disclosure. One or more components of the example disaggregated base station architecture 300 may be, may include, or may be included in one or more network nodes (such as one or more network nodes 105). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). In some implementations, the core network 320 includes or corresponds to the core network 120 of FIG. 1. The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 115 via respective RF access links. In some deployments, a UE 115 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally, or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

The UEs 115, the CU 310, the DUs 330, the RUs 340, or any other component(s) of FIG. 3 may implement one or more techniques or perform one or more operations associated with UL signal transmission by a multi-transceiver device, as described further herein. For example, the UEs 115 may include the multi-transceiver wakeup manager 150 and the RUs 340 may include the multi-transceiver wakeup manager 152, which may manage operations to support configuring UL signal transmission for a multi-transceiver device. Although shown as being included in a single UE 115 in FIG. 3, any of the UEs 115 may include the multi-transceiver wakeup manager 150, and although shown as being included in a single RU 340 in FIG. 3, any of the RUs 340, the DUs 330, the CU 310, the Non-RT RIC 350, the SMO Framework 360, the Near-RT RIC 370, or a combination thereof, may include the multi-transceiver wakeup manager 152. The multi-transceiver wakeup manager 150 may direct operations of, for example, the process 1300 of FIG. 13, or other processes as described herein (alone or in conjunction with one or more other processors). Similarly, the multi-transceiver wakeup manager 152 may direct operations of, for example, the process 1500 of FIG. 15, or other processes as described herein (alone or in conjunction with one or more other processors).

In some examples, the multi-transceiver wakeup manager 150 or the multi-transceiver wakeup manager 152 may include, or have access to, a non-transitory computer-readable medium storing a set of instructions (for example, code or program code) for wireless communication. The memory may include one or more memories, such as a single memory or multiple different memories (of the same type or of different types). For example, the set of instructions, when executed (for example, directly, or after compiling, converting, or interpreting) by the multi-transceiver wakeup manager 150 or one or more processors of the UE 115 may cause the one or more processors or the multi-transceiver wakeup manager 150 to perform the process 1300 of FIG. 13, or other processes as described herein. As another example, the set of instructions, when executed (for example, directly, or after compiling, converting, or interpreting) by the multi-transceiver wakeup manager 152, one or more processors of the network node 105, the CU 310, the DU 330, the RU 340, the Non-RT RIC 350, the SMO Framework 360, or the Near-RT RIC 370, may cause the one or more processors or the multi-transceiver wakeup manager 152 to perform the process 1500 of FIG. 15, or other processes as described herein. In some examples, executing instructions (or code) may include running the instructions, converting the instructions, compiling the instructions, and/or interpreting the instructions, among other examples.

FIG. 4 is a block diagram illustrating an example wireless communication system 400 that supports configuring UL signal transmission for a multi-transceiver UE in accordance with the present disclosure. In some examples, the wireless communication system 400 may implement aspects of the wireless communication network 100. The wireless communication system 400 includes the UE 115 and the network node 105. Although one UE 115 and one network node 105 are illustrated, in some other implementations, the wireless communication system 400 may generally include multiple UEs 115, multiple network nodes 105, or both.

The UE 115 can include a variety of components (such as structural, hardware components) used for carrying out one or more functions described herein. For example, these components can include one or more processors 402 (hereinafter referred to collectively as “the processor 402”), one or more memory devices 404 (hereinafter referred to collectively as “the memory 404”), one or more transceivers 414 (hereinafter referred to collectively as “the transceiver 414”), and one or more LP transceivers 416 (hereinafter referred to collectively as “the LP transceiver 416”). Although referred to as a processor 402, the UE 115 may include one or more chips, system-on-chips (SoCs), chipsets, packages, or devices that individually or collectively constitute or include a processing system. The processing system includes processor (or “processing”) circuitry in the form of one or multiple processors (such as the processor 402), microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor 402” or “the processor circuitry”).

One or more of the processors 402 may be individually or collectively configurable or configured to perform various functions or operations described herein. A group of processors, such as the processors 402, collectively configurable or configured to perform a set of functions may include a first processor configurable or configured to perform a first function of the set of functions and a second processor configurable or configured to perform a second function of the set of functions, or may include the group of processors all being configured or configurable to perform the set of functions. The processor 402 may be configured to execute code 405, such as one or more instructions of processor-readable code, stored in the memory 404 to perform the operations described herein. In some implementations, the processor 402 includes or corresponds to the receive processor 258, the transmit processor 264, the controller 280, or a combination thereof, and the memory 404 includes or corresponds to the memory 282, described with reference to FIG. 2. In some implementations, the processor 402, the memory 404, the code 405, another component of the UE 115, or a combination thereof, may include or correspond to the multi-transceiver wakeup manager 150 of FIGS. 1-3 and/or may perform the operations associated with the multi-transceiver wakeup manager 150 to support UL signal transmission by a multi-transceiver UE. In some implementations, a “processing system” includes one or more processors (the processor 402) and one or more memories (the memory 404) that store the code 405 and are coupled with one or more processors. In such embodiments, such a processing system is configured to cause the UE 115 to perform the operations described herein.

The memory 404 may be configured to store the code 405 and predefined transmission signal samples 406. The predefined transmission signal samples 406 may include samples of signals that are generated by the UE 115 and stored in the memory 404 for use in generating UL transmission signals to be transmitted during a wakeup signal (WUS) monitoring period, as further described herein. Although shown in FIG. 4 as a single memory 404, in some implementations, the memory 404 may include at least two memories, such as a “main memory” associated with the transceiver 414 and an “LP transceiver memory” associated with the LP transceiver 416.

The transceiver 414 is configured to transmit reference signals, control information and data to one or more other devices, and to receive reference signals, synchronization signals, control information and data from one or more other devices. For example, the transceiver 414 may transmit signaling, control information and data to, and receive signaling, control information and data from, the network node 105. In some implementations, the transceiver 414 includes, or has integrated within, a transmitter and a receiver. Additionally, or alternatively, the transceiver 414 may include or correspond to one or more components of the UE 115 described with reference to FIG. 2. The transceiver 414 may be referred to as a main transceiver or a primary transceiver, and the transceiver 414 may be configured to transmit or receive signaling, control information, and data during a normal operating mode or active operating mode associated with the UE 115.

The LP transceiver 416 is configured to transmit a limited subset of signaling to one or more other devices, and to receive a limited subset of signaling from one or more other devices. For example, the LP transceiver 416 may transmit the limited subset of signaling to, and receive the limited subset of signaling from, the network node 105. In some implementations, the LP transceiver 416 includes, or has integrated within, an LP transmitter and an LP receiver. Additionally, or alternatively, the LP transceiver 416 may include or correspond to one or more components of the UE 115 described with reference to FIG. 2. The LP transceiver 416 may be referred to as a “low-power” transceiver or a secondary transceiver, because power consumed by the LP transceiver 416 to send or receive signaling is less than power consumed by the transceiver 414 to send or receive signaling. It is noted that the “low-power” aspect of the LP transceiver 416 refers to the power consumption of the LP transceiver 416 to send or receiving signaling and not to the signal strength or signal power of the signals that are sent or received. The LP transceiver 416 may be configured to transmit or receive during an LP operating mode or a sleep mode associated with the UE 115. In some implementations, the LP transceiver 416 is capable of being activated and deactivated quickly, as compared to the transceiver 414, and the LP transceiver 416 is capable of receiving, generating, and processing “simple” signals of the limited subset of signaling, such as signals within limited bandwidths and having simpler waveforms, as compared to the signaling of the transceiver 414.

In some implementations, the LP transceiver 416 is configured to communicate using on-off keying (OOK) waveforms, such as OOK-1 waveforms or OOK-4 waveforms, as non-limiting examples. In suck OOK waveforms, a particular duration of high signal power (or low signal power) can represent an information bit. In some such implementations, the durations of high signal power may be overlaid with an orthogonal frequency division multiplexing (OFDM) sequence to convey additional information. The OFDM sequence may include a Gold sequence, a maximum length sequence (m-sequence), a computer searched sequence, a Zadoff-Chu (ZC) sequence, or a Golay sequence, as illustrative, non-limiting examples. Such sequences can be capable of being decoded without frequency demodulation at a receiving device, such as by detection of a cyclic shift or another characteristic, which can be used to represent information such as a parameter value, as further described herein.

The network node 105 can include a variety of components (such as structural, hardware components) used for carrying out one or more functions described herein. For example, these components can include one or more processors 450 (hereinafter referred to collectively as “the processor 450”), one or more memory devices 452 (hereinafter referred to collectively as “the memory 452”), one or more transmitters 462 (hereinafter referred to collectively as “the transmitter 462”), and one or more receivers 464 (hereinafter referred to collectively as “the receiver 464”). Although referred to as a processor 450, the network node 105 may include one or more chips, SoCs, chipsets, packages, or devices that individually or collectively constitute or include a processing system. The processing system includes processor (or “processing”) circuitry in the form of one or multiple processors (such as the processor 450), microprocessors, processing units (such as CPUs, GPUs, NPUs and/or DSPs), processing blocks, ASICs, PLDs (such as FPGAs), or other discrete gate or transistor logic or circuitry (all of which may be generally referred to herein individually as “processors” or collectively as “the processor 450” or “the processor circuitry”).

One or more of the processors 450 may be individually or collectively configurable or configured to perform various functions or operations described herein. A group of processors, such as the processors 450, collectively configurable or configured to perform a set of functions may include a first processor configurable or configured to perform a first function of the set of functions and a second processor configurable or configured to perform a second function of the set of functions, or may include the group of processors all being configured or configurable to perform the set of functions. The processor 450 may be configured to execute code 453, such as one or more instructions, stored in the memory 452 to perform the operations described herein. In some implementations, the processor 450 includes or corresponds to the receive processor 238, the transmit processor 220, the controller 240, or a combination thereof, and the memory 452 includes or corresponds to the memory 242, described with reference to FIG. 2. In some implementations, the processor 450, the memory 452, the code 453, another component of the network node 105, or a combination thereof, may include or correspond to the multi-transceiver wakeup manager 152 of FIGS. 1-3 and/or may perform the operations associated with the multi-transceiver wakeup manager 152 to support configuring UL signal transmission for a multi-transceiver UE. In some implementations, a “processing system” includes one or more processors (the processor 450) and one or more memories (the memory 452) that store the code 453 and are coupled with one or more processors. In such embodiments, such a processing system is configured to cause the network node 105 to perform the operations described herein.

The memory 452 may be configured to store the code 453 and, optionally, additional data to support the operations described herein. The transmitter 462 is configured to transmit reference signals, synchronization signals, control information, and data to one or more other devices, and the receiver 464 is configured to receive reference signals, control information and data from one or more other devices. For example, the transmitter 462 may transmit signaling, control information and data to, and the receiver 464 may receive signaling, control information and data from, the UE 115. In some implementations, the transmitter 462 and the receiver 464 may be integrated in one or more transceivers. Additionally, or alternatively, the transmitter 462 or the receiver 464 may include or correspond to one or more components of network node 105 described with reference to FIG. 2.

In some implementations, the wireless communication system 400 is configured to implement a 5G NR network or a 6G network. For example, the wireless communication system 400 may include multiple 5G-capable UEs 115 (or 6G-capable UEs 115) and multiple 5G-capable network nodes 105 (or 6G-capable network nodes 105), such as UEs and network nodes configured to operate in accordance with a 5G NR network protocol, or a 6G network protocol, such as that defined by the 3GPP. In some examples, the wireless communication system 400 includes multiple multi-transceiver UEs 115.

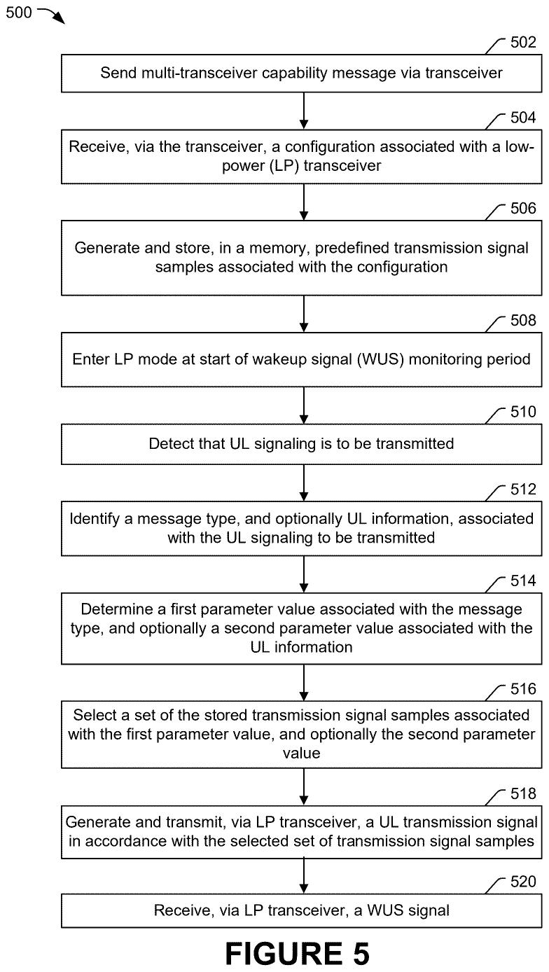

During operation of the wireless communication system 400, the UE 115 and the network node 105 may perform one or more operations shown in FIG. 5, which is a flow diagram illustrating an example of a process 500 that supports UL signal configuration and transmission by the multi-transceiver UE 115 of FIG. 4 in accordance with the present disclosure. The UE 115 begins the process 500 in a normal operating mode, also referred to as an active operating mode, in which the transceiver 414 is active and the LP transceiver 416 is in a powered down mode or sleep mode, also referred to as deactivated. For example, the UE 115 may enter the normal operating mode when the UE 115 is powered on, upon a command from an application being executed at the UE 115, or after receiving a WUS from the network node 105, as non-limiting examples, and to enter the normal operating mode, the UE 115 may activate the transceiver 414 and deactivate the LP transceiver 416.

While operating in the normal operating mode, the UE 115 may perform wireless communications via the transceiver 414, and the LP transceiver 416 remains deactivated or turned off. The transceiver 414 is capable of transmitting and receiving a wider variety of signaling than the LP transceiver 416, and thus the UE 115 may operate in the normal operating mode during time periods when there is a significant amount of data to be transmitted or received, when the UE 115 is performing wireless communications associated with higher throughput or signal quality criteria, or during other time periods. Because a power consumption rate associated with the normal operating mode (an “active mode”) is greater than a power consumption rate associated with an LP mode (a “powered-down mode”), the UE 115 may be configured to enter the LP mode at times to conserve power, as further described below.

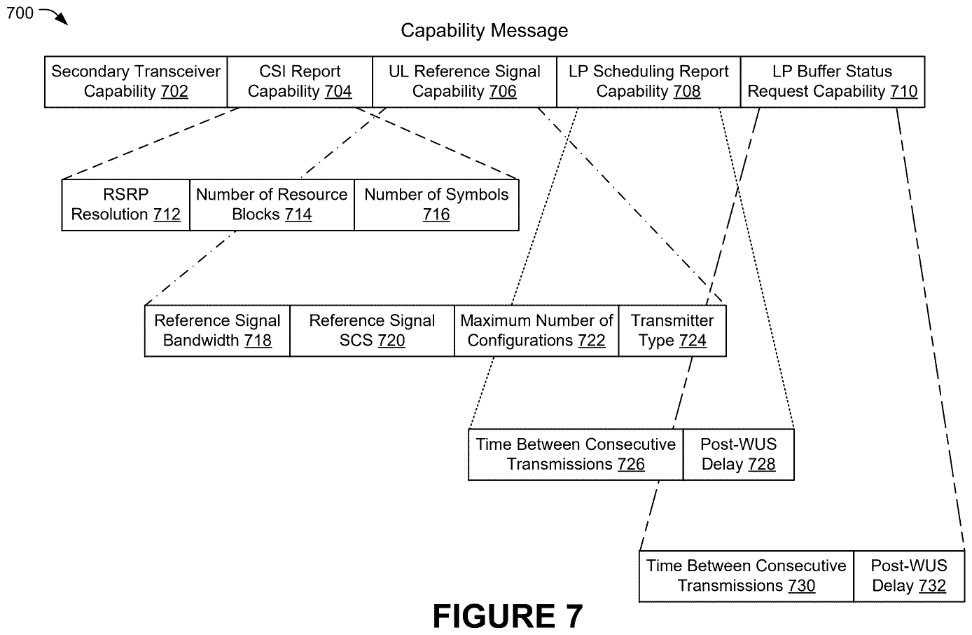

At 502, the UE 115 sends, via the transceiver 414, a capability message 478 to the network node 105. In some implementations, the UE 115 sends the capability message 478 as radio resource control (RRC) signaling. The capability message 478, which may be referred to as a multi-transceiver capability message, indicates various types of signaling and related parameters that are capable of being transmitted by the UE 115 using the LP transceiver 416. As non-limiting examples, the capability message 478 may indicate a channel state information (CSI) report capability associated with the LP transceiver 416, a UL reference signal capability associated with the LP transceiver 416, an LP scheduling request capability associated with the LP transceiver 416, an LP buffer status report capability associated with the LP transceiver 416, or a combination thereof. An example of such a capability message is further described herein, with reference to FIG. 7.

At 504, the network node 105 sends a configuration 470 to the UE 115. For example, the network node 105 may generate the configuration 470 for the UE 115 in accordance with the capability message 478. In some implementations, the network node 105 sends the configuration 470 as RRC signaling. The UE 115 receives the configuration 470 via the transceiver 414. The configuration 470, which is associated with the LP transceiver 416, indicates various UL signaling configurations to be sent by the UE 115 during a WUS monitoring period. Stated another way, the network node 105 may configure various types of UL signaling to be performed by the UE 115 by sending the configuration 470 to the UE 115. In some implementations, the configuration 470 may also indicate one or more UL signaling configurations to be sent by the UE 115 using the transceiver 414 during operation in the normal operating mode. In such implementations, the configuration 470 may be referred to as a multi-transceiver transmission configuration.

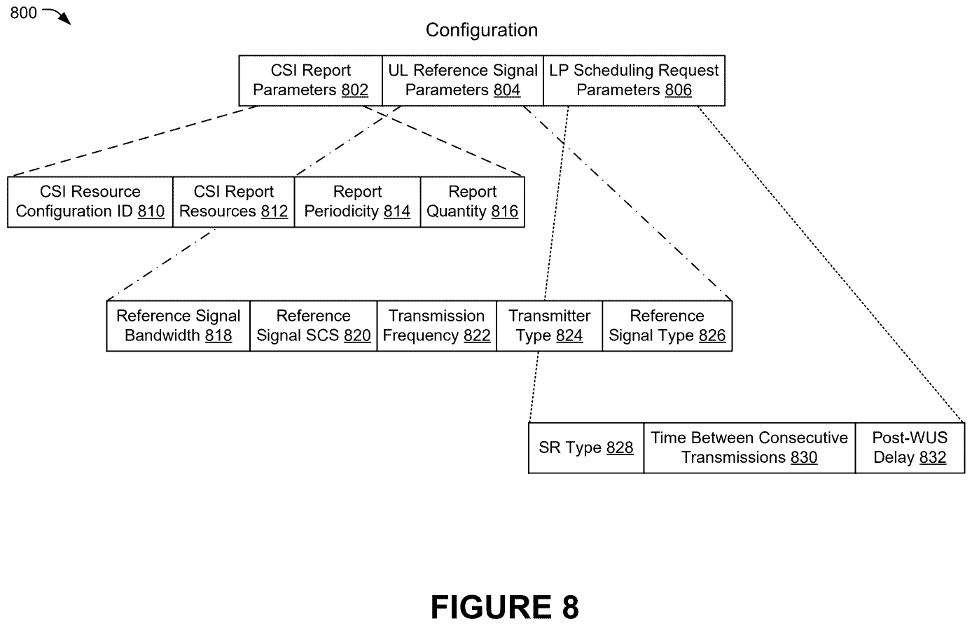

To configure UL signaling that is to be sent using the LP transceiver 416, the configuration 470 includes one or more transmit parameters 472 (hereinafter referred to collectively as “the transmit parameters 472”). The transmit parameters 472 may be used to generate UL transmit signaling to be sent by the UE 115 during a WUS monitoring period when the UE 115 is to be operating in the LP mode with the transceiver 414 deactivated. As non-limiting examples, transmit parameters 472 may include parameters associated with a CSI report, a UL reference signal, an LP scheduling request, an LP buffer status report, or a combination thereof. An example of such a configuration is further described herein, with reference to FIG. 8. The WUS monitoring period may be a duration of time during which the UE 115 is permitted to operate in the LP mode unless a WUS with an instruction to transition to the active mode is received from the network node 105. In some implementations, a duration of the WUS monitoring period, criteria for entering the WUS monitoring period, and/or other rules or parameters associated with the WUS monitoring period may be stored at the UE 115 and the network node 105, and in some implementations, may be defined in one or more wireless communication standards.

At 506, the UE 115 generates and stores, in the memory 404, the predefined transmission signal samples 406. The predefined transmission signal samples 406 are “simpler” signals that are capable of being transmitted by the LP transceiver 416, which has a power consumption rate less than the transceiver 414. For example, the predefined transmission signal samples 406 may include samples of OOK waveforms, samples of OOK waveforms with overlaid OFDM sequences, or samples of other types of waveforms or signals that are capable of being decoded without frequency demodulation at a receiver.

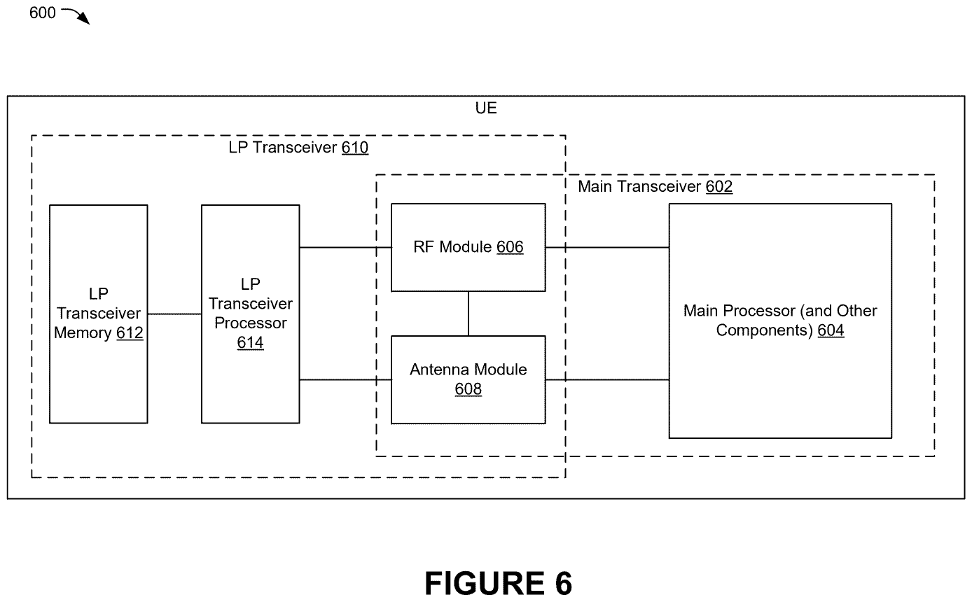

In some implementations, the predefined transmission signal samples 406 include samples of various types of signals, such as OOK signals, OOK signals overlaid with orthogonal frequency division multiplexing sequences, or other types of signals that are capable of being decoded without being frequency demodulated, and as such, the parameters may include index values of mathematical sequences used to generate the predefined transmission signals, cyclic shifts applied to the mathematical sequences, or sets of subcarriers via which the predefined transmission signals are transmitted (also referred to as “active subcarriers”). Additionally, or alternatively, each of the predetermined transmission signals may be generated and sampled while the UE 105 is operating in the normal operating mode and using the transceiver 414. Such predefined transmission signal samples may be stored in a portion of the memory 404 or a distinct LP transceiver memory (as described with reference to FIG. 6) that is accessible to the LP transceiver 416 while the UE 105 is in the LP mode. By preprocessing and sampling predefined transmission signals while the UE 105 is in the normal operating mode and storing the predefined transmission signal samples 406 in the memory 404, the LP transceiver 416 is enabled to generate UL transmission signals using the predefined transmission signal samples 406, which consumes less power than processing and generating the signals in real-time during operation in the LP mode using the transceiver 414.

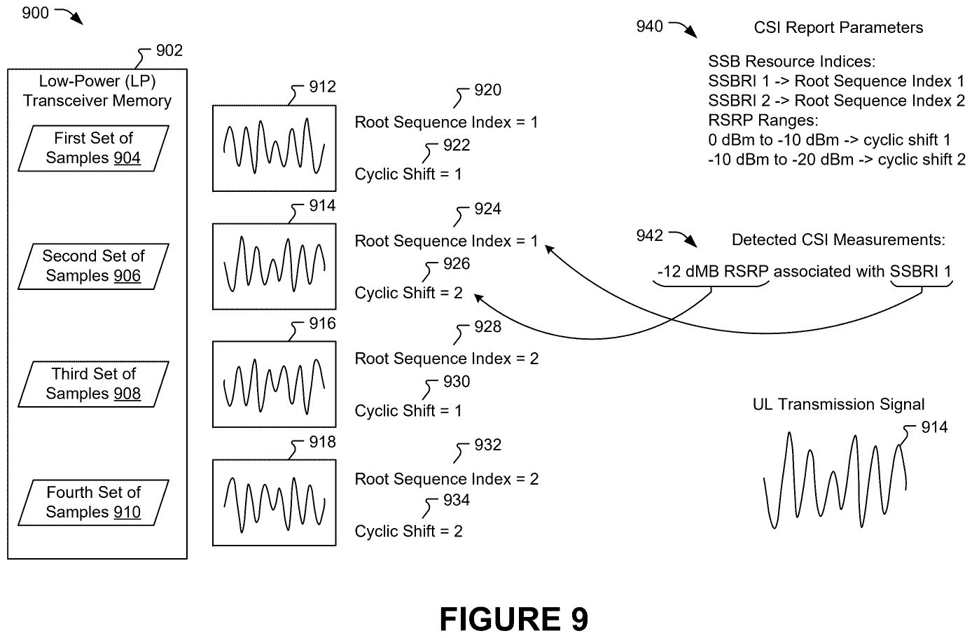

As an illustrative example, the predefined transmission signal samples 406 are associated with the configuration 470, such that the predefined transmission signal samples 406 are collected from signals that are generated by the transceiver 414 and that correspond to one or more of the signaling types that are configured by the configuration 470. For example, if the transmit parameters 472 include one or more CSI report parameters, the predefined transmission signal samples 406 may include samples of one or more transmission signals that, when decoded, indicate one or more CSI values in accordance with a relationship between signal parameters and CSI values indicated by the transmit parameters 472. In this example, different CSI values may be indicated by two transmission signals that each are generated in accordance with the same ZC sequence and that each have different cyclic shifts. As another example, if the transmit parameters 472 include one or more UL reference signal parameters, the predefined transmission signal samples 406 may include samples of one or more UL reference signals that are configured by the transmit parameters 472. As another example, if the transmit parameters 472 include one or more LP scheduling request parameters or LP buffer status report parameters, the predefined transmission signal samples 406 may include samples of one or more LP scheduling request signals or LP buffer status report signals configured by the transmit parameters 472. Additional details and examples of predefined transmit signal samples, and the relationship between associated parameter values and message parameters or information is described further herein with reference to FIG. 9.

At 508, the UE 115 deactivates the transceiver 414 and activates the LP transceiver 416 to enter into the LP operating mode at the start of a WUS monitoring period. Although operating in the normal operating mode enables the UE 115 to perform higher quality or more complicated wireless communications, operating in the normal operating mode consumes more power than operating in the LP operating mode. Thus, to reduce power consumption, the UE 115 may enter the LP operating mode at various times, such as when there is not a significant amount of data to be transmitted or expected to be received, when wireless communications by the UE 115 are not subject to signal quality or throughput criteria, or when instructed by the network node 105, as non-limiting examples.

At 510, the UE 115 detects that UL signaling is to be transmitted to the network node 105. For example, if a type of UL signaling is associated with periodic transmissions in accordance with the transmit parameters 472, the UE 115 may detect that UL signaling is to be transmitted according to an associated periodicity. As another example, the UE 115 may detect that UL signaling is to be transmitted in accordance with receiving an explicit indication or request from the network node 105. In this example, a WUS or other similar signal that is capable of being decoded without performing frequency demodulation and that has an explicit or implicit indication of request for UL signaling may be transmitted by the network node 105, and upon receipt and decoding of the WUS, the UE 115 may determine to transmit UL signaling. As another example, an application that is being executed by the UE 115 may provide an instruction or indication that UL signaling is to be transmitted to the network node 105.

At 512, the UE 115 identifies a message type, and optionally UL data/control information 476, associated with the UL signaling to be transmitted. The message type refers to the type of UL signaling or messaging to be transmitted by the UE 115. For example, the message type may be a CSI report, a UL reference signal, an LP scheduling request, or an LP buffer status report (which represents an LP scheduling request), as non-limiting examples. Some message types include UL data or control information, represented in FIG. 4 as the optional UL data/control information 476. For example, the UL data/control information 476 may include one or more CSI measurements or CSI parameter values if the message type is a CSI report. Some other message types do not include UL data or control information, and thus do not include the UL data/control information 476. For example, a UL reference signal, an LP scheduling request, or an LP buffer status report that represents an LP scheduling request may not include any additional UL data or control information.

At 514, the UE 115 determines a first parameter value associated with the message type, and optionally a second parameter value associated with the UL data/control information 476. The first parameter value and the second parameter value are associated with the predefined transmission signals that were sampled by the UE 115 and stored as the predefined transmission signal samples 406. For example, if the predefined transmission signals are generated in accordance with a mathematical sequence, the first parameter may include an index value of the mathematical sequence, and the second parameter may include a cyclic shift applied to the mathematical sequence. In some such examples, the mathematical sequence is a ZC sequence, and the index value is a root sequence index of the ZC sequence. In some other such examples, the mathematical sequence is an m-sequence, and the index value is a primitive polynomial of the m-sequence. Alternatively, if the predefined transmission signals are transmitted via multiple subcarriers, the first parameter value indicates at least one first subcarrier of a first set of subcarriers, and the second parameter value indicates at least one second subcarrier of a second set of subcarriers.

Values of the first parameter may be mapped to various message types, or other signal parameters, by the configuration 470. For example, if the predefined transmission signals are generated in accordance with a ZC sequence, the configuration 470 may indicate associations between root sequence index values and message types. As an illustrative example, the configuration 470 may indicate that a first root sequence index value is associated with or indicates a CSI report message, a second root sequence index value is associated with or indicates a UL reference signal, a third root sequence index value is associated with or indicates an LP scheduling request, and a fourth root sequence index value is associated with or indicates an LP buffer status report. Additionally, values of the second parameter may be mapped to various UL data or control information, or other signal parameters, by the configuration 470. For example, if the predefined transmission signals are generated in accordance with a ZC sequence and the message type is a CSI report, the configuration 470 may indicate associations between cyclic shift values and CSI measurement values. As an illustrative example, the configuration 470 may indicate that a cyclic shift value is associated with or indicates a first CSI measurement value or range of values, a second cyclic shift value is associated with or indicates a second CSI measurement value or range of values, a third cyclic shift value is associated with or indicates a third CSI measurement value or range of values, and a fourth cyclic shift value is associated with or indicates a fourth CSI measurement value or range of values. Similar associations may be provided between message types and primitive polynomial values or first sets of subcarriers, and between UL data or control information and cyclic shift values or second sets of subcarriers, by the configuration 470. Additional examples of determining parameter values in accordance with message parameters and/or UL data or control information are described further herein with reference to FIG. 9.

In a particular example, the UE 115 may determine that a CSI report is to be transmitted and, based on one or more channel measurements performed using the LP transceiver 416, that a reference signal received power (RSRP) is approximately −15 decibel milliwatts (dBm). In this example, the configuration 470 indicates that a first root sequence index value of a group of root sequence index values is associated with CSI messages and a second cyclic shift value of a group of cyclic shift values is associated with RSRP measurements between −10 dBm and −20 dBm. Accordingly, the UE 115 may determine that a predefined transmission signal associated with a root index value equal to the first root index value and a cyclic shift equal to the second cyclic shift value represents a CSI report that indicates an RSRP that is between −10 dBm and −20 dBm.

At 516, the UE 115 selects a set of the predefined transmission signal samples 406 associated with the first parameter value, and optionally with the second parameter value. In the above-described example, the UE 115 may select a set of predefined transmission signal samples, from the predefined transmission signal samples 406, that is associated with the first root index value (the first parameter value) and the second cyclic shift value (the second parameter value). Additional details of selecting sets of the predefined transmission signal samples 406 in accordance with determined parameter values are described further herein with reference to FIG. 9.

At 518, the UE 115 generates a UL transmission signal 474, and transmits the UL transmission signal 474 to the network node 105 via the LP transceiver 416, in accordance with the selected set of the predefined transmission signal samples 406. For example, the UE 115 may use the LP transceiver 416 to generate and transmit a UL signal that is based on the selected set of predefined transmission signals. Generating the UL transmission signal 474 using a set of samples and the LP transceiver 416 may use less power than generating a signal using the transceiver 414 and without using stored samples. Thus, transmitting the UL transmission signal 474 via the LP transceiver 416 may reduce power consumption at the UE 115 while still communicating the information indicated by the UL transmission signal 474 to the network node 105, as compared to generating and transmitting a UL transmission signal using the transceiver 414 after transitioning from the LP mode to the normal operating mode.

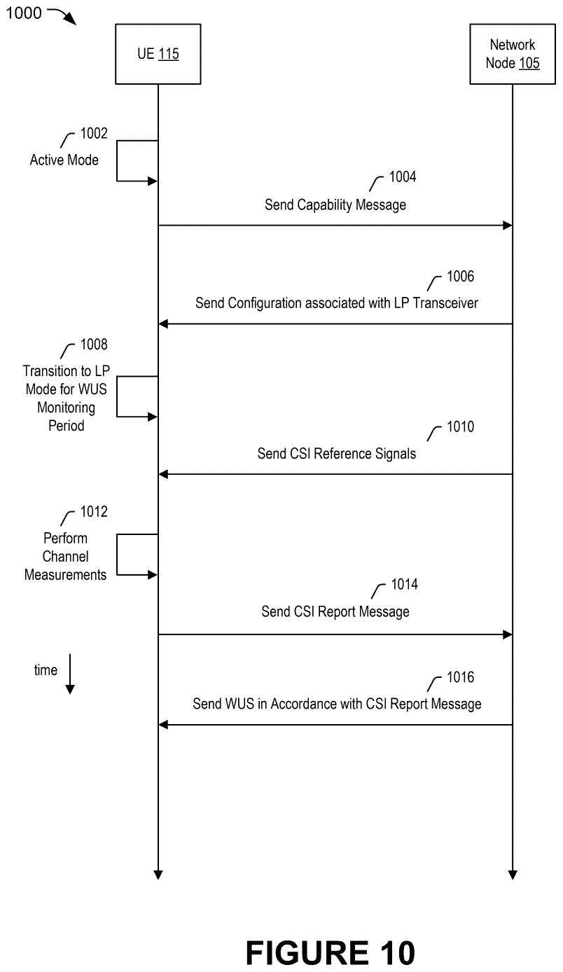

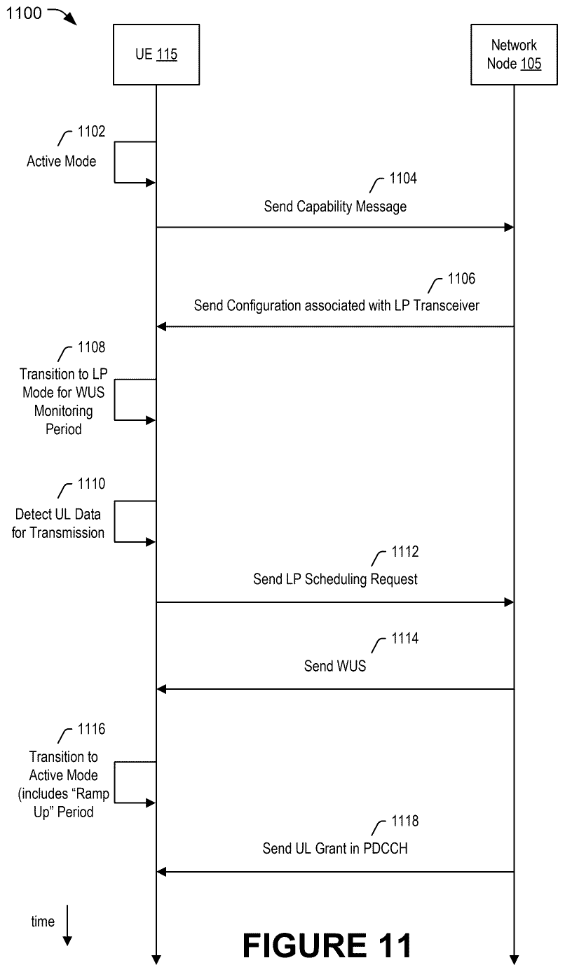

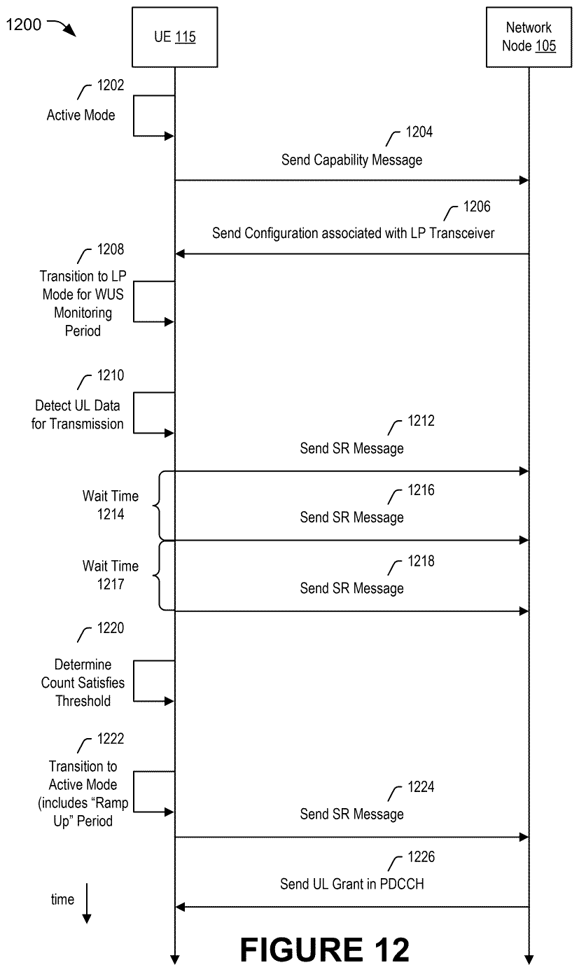

In some examples, the UL transmission signal 474 indicates a CSI report message, and the UL transmission signal 474 includes or indicates the UL data/control information 476, which may indicate an RSRP value or another channel measurement. An example of transmitting a CSI report using an LP transceiver is further described herein, with reference to FIG. 10. In some other examples, the UL transmission signal 474 indicates an LP scheduling request or an LP buffer status report, and in such examples, the UL transmission signal 474 may not include or indicate the UL data/control information 476. Examples of transmitting an LP scheduling request using an LP transceiver is further described herein, with reference to FIGS. 11-12.

In some other examples, the UL transmission signal 474 is a UL reference signal. For example, the UL transmission signal 474 may be a sounding reference signal (SRS) or another type of UL reference signal. The UE 115 may transmit the SRS (or another UL reference signal) to the network node 105, and the network node 105 can use received SRS to estimate a wireless channel between the UE 115 and the network node 105, as well as to adjust one or more parameters of DL signals, such as a WUS signal, accordingly. For example, the network node 105 may determine, in accordance with the SRS or other UL reference signal represented by the UL transmission signal 474, a number of chips (M) in one OFDM symbol of DL signals to the LP transceiver 416, a pathloss of the wireless channel between the UE 115 and the network node 105 (which can be used to determine if the UE 115 is in or out of range of DL signals to the LP transceiver 416), other parameter values, or a combination thereof.

At 520, the network node 105 transmits a WUS 480 to the UE 115 during the WUS monitoring period. In some examples, the network node 105 may determine one or more DL transmit parameters in accordance with the UL transmission signal 474, and the network node 105 may transmit the WUS 480 in accordance with the one or more DL transmit parameters. For example, the one or more DL transmit parameters may include the above-described number of chips in an OFDM signal, the pathloss of the wireless channel between the UE 115 and the network node 105, or both. As another example, if the UL transmission signal 474 is a CSI report message, the one or more DL transmit parameters may include one or more parameters that compensate for a strength of the wireless channel between the UE 115 and the network node 105 that are determined by the network node 105 using one or more channel measurement values indicated by the UL transmission signal 474.

The UE 115 may receive the WUS 480 via the LP transceiver 416 during the WUS monitoring period. In some implementations, the WUS 480 is a DL control signal that indicates one or more updated values of the transmit parameters 472, an instruction to send an UL transmission signal, an instruction to enter the active mode (the normal operating mode), or a combination thereof. For example, the network node 105 may determine one or more updated values of the transmit parameters 472 in accordance with a CSI measurement received from the UE 115, in examples in which the UL transmission signal 474 is a CSI report message, or in accordance a UL reference signal received from the UE 115, in examples in which the UL transmission signal 474 is a UL reference signal such as a SRS. In examples in which the WUS 480 indicates an instruction to “wake up” and enter the active mode, the UE 115 activates the transceiver 414 and deactivates the LP transceiver 416, responsive to receiving the WUS 480. There may be a “ramp up” time between activating the transceiver 414 and the transceiver being fully powered on and capable of transmitting or receiving wireless signals, as further described herein with reference to FIGS. 11-12.

As described with reference to FIGS. 4-5, the present disclosure provides techniques for supporting configuration of UL transmissions for a multi-transceiver device. For example, the UE 115 may be configured, through selection of the transmit parameters 472 included in the configuration 470 by the network node 105, to support one or more types of UL signal transmission during WUS monitoring periods in which the UE 115 is operating in the LP mode. During a WUS monitoring period, the UE 115 may transmit the UL transmission signal 474 via the LP transceiver 416 to indicate a UL message, such as a CSI report message, a UL reference signal, an LP scheduling request, or an LP buffer status report, and the LP transceiver 416 may generate and transmit the UL transmission signal 474 using a selected set of the predefined transmission signal samples 406. Because the predefined transmission signals are relatively less complex or “simple” signals, such as OOK signals, OOK signals overlaid with OFDM sequences, or other types of less complex signals, and because the LP transceiver 416 generates the UL transmission signal 474 using some of the predefined transmission signal samples 406, the LP transceiver 416 is associated with a lower power consumption rate than the transceiver 414. Accordingly, the UE 115 is capable of providing UL transmission signals to the network node 105 while remaining in the LP mode, and thus consuming less power, than transitioning to the normal operating mode to transmit a corresponding UL transmission signal via the transceiver 414. In this manner, the wireless communication system 400 enables the UE 115 to reduce power consumption while also enabling the network node 105 to receive the UL data/control information 476 that can be used to improve wireless communications between the network node and the UE 115 while the UE 115 is operating in the LP mode.

FIG. 6 is a block diagram illustrating an example of a multi-transceiver UE 600 that supports UL signal transmission in accordance with the present disclosure. In some implementations, the UE 600 includes or corresponds to the UE 115 of FIGS. 1-4. In the example shown in FIG. 6, the UE 600 includes a main transceiver 602 and an LP transceiver 610. In some examples, the main transceiver 602, which may also be referred to as a primary transceiver, includes or corresponds to the transceiver 414 of FIG. 4, and the LP transceiver 610, which may also be referred to as a secondary transceiver, includes or corresponds to the LP transceiver 416 of FIG. 4.

In the example shown in FIG. 6, the main transceiver 602 and the LP transceiver 610 may share one or more components of the UE 600, in addition to including one or more respective individual components. For example, the main transceiver 602 may include a main processor 604 (and optionally, other components, such as a main transceiver memory), an RF module 606, and an antenna module 608, and the LP transceiver 610 may include an LP transceiver memory 612 and an LP transceiver processor 614 in addition to sharing use of the RF module 606 and the antenna module 608 with the main transceiver 602. The RF module 606 and the antenna module 608 may include one or more components of one or more RF chains, one or more antennas or antenna chains, or a combination thereof, similar to as described above with reference to FIG. 2. The main transceiver 602 and the LP transceiver 610 may be configured to share some components, such as the RF module 606 and the antenna module 608, to reduce an overall cost associated with the UE 600. In such an example, the shared components, such as the RF module 606 and the antenna module 608, may be used by the LP transceiver 610 at reduced capabilities, to further decrease a power consumption rate of the LP transceiver 610 as compared to a power consumption rate of the main transceiver 602.

The main processor 604 may include one or more processors or a processing system that are configured to support the operations of the main transceiver 602 (and optionally, other operations of the UE 600). The LP transceiver memory 612 and the LP transceiver processor 614 may include or correspond to a limited memory and a limited processor, respectively, that are configured to support operations of the LP transceiver 610 and that consume less power while activated than the main processor 604. For example, the LP transceiver processor 614 may have limited (or “simple”) capabilities that include supporting frequency and time synchronization operations, RSRP measurements, other such limited operations, or a combination thereof. Additionally, or alternatively, the LP transceiver memory 612 may be configured to store predefined transmission signal samples, such as the predefined transmission signal samples 406 of FIG. 4, for use in enabling the LP transceiver 610 to transmit certain UL signals during a WUS monitoring period. In some implementations, the LP transceiver memory 612 is also configured to store a portion or an entirety of the configuration 470.

During operation of the UE 600, if the UE 600 is operating in a normal operating mode (an active mode), the UE 600 activates the main transceiver 602 and deactivates the LP transceiver 610. While operating in the normal operating mode, the UE 600 transmits and/or receives wireless signaling or data via the main transceiver 602. In some implementations, the LP transceiver memory 612 may also be activated in order to store the predefined transmission signal samples that the UE 600 generates using the main transceiver 602.

To reduce power consumption, the UE 600 is also configured to operate in an LP mode (a sleep mode) during which the UE 600 switches off or powers down the main processor 604 (and optionally other components of the main transceiver 602 except for the RF module 606 and the antenna module 608) to reduce power consumption, in addition to activating the LP transceiver processor 614 (and optionally the LP transceiver memory 612 if the LP transceiver memory 612 is disabled). While the UE 600 is operating in the LP mode, to transmit a UL signal, the LP transceiver processor 614 accesses the LP transceiver memory 612 to retrieve a set of the predefined transmission signal samples for use in generating and transmitting the UL signal. In some examples, the UE 600 pre-generates and preprocesses one or more predefined transmission signals and stores samples of these preprocessed signals in the LP transceiver memory 612 as one or more waveforms, such as by storing I/Q samples of the preprocessed signals that represent real and imaginary components of a respective complex-valued baseband signal.

Because the LP transceiver memory 612 is limited, the signals that are sampled by the UE 600 are relatively simple and are capable of being pre-generated and stored as samples in the LP transceiver memory 612, such as signals that are generated in accordance with mathematical sequences such as a ZC sequence or an m-sequence, or signals that are transmitted across multiple subbands for the purpose of indicating whether the subbands are “powered,” such as if detectable signal present within the subbands or not without decoding the actual signal. To transmit the UL signal via the LP transceiver 610, the LP transceiver processor 614 retrieves a set of predefined transmission signal samples having one or more parameter values that match determined parameter values associated with aspects of the UL signal to be sent, and the LP transceiver processor 614 provides a signal based on the retrieved set of predefined transmission signal samples to the RF module 606 and the antenna module 608 for transmission, such as to the network node 105 of FIG. 4.

FIG. 7 is a block diagram illustrating an example of a UE capability message 700 in accordance with the present disclosure. In some implementations, the UE capability message 700 includes or corresponds to the capability message 478 of FIG. 4. In some examples, the UE capability message 700 is an RRC message that is communicated via RRC signaling by a UE to a network node, such as the UE 115 and the network node 105, respectively.

In the example shown in FIG. 7, the UE capability message 700 includes a secondary transceiver capability field 702, a CSI report capability field 704, a UL reference signal capability field 706, an LP scheduling request capability field 708, and an LP buffer status report capability field 710. In other examples, the UE capability message 700 may include fewer than five fields, more than five fields, one or more different fields than shown in FIG. 7, one or more of the fields 702-710 may be omitted, or a combination thereof.

The secondary transceiver capability field 702 indicates whether the UE supports an LP mode in addition to a normal operating mode. For example, if the secondary transceiver capability field 702 has a first value, such as a logical zero value, the secondary transceiver capability field 702 indicates that the UE does not include an LP transceiver, also referred to as a secondary transceiver, and thus supports the normal operating mode but not the LP mode. In this example, if the secondary transceiver capability field 702 has a second value, such as a logical one value, the secondary transceiver capability field 702 indicates that the UE includes the LP transceiver and thus supports both the normal operating mode and the LP mode. In some implementations, the secondary transceiver capability field 702 may include or correspond to a bit or a flag that indicates whether the UE supports the LP mode (or whether the UE includes a respective LP transceiver).

The CSI report capability field 704 indicates one or more parameters associated with transmitting an LP CSI report message by the UE using the LP transceiver. For example, the CSI report capability field 704 may include an RSRP resolution subfield 712, a number of resource blocks subfield 714, and a number of symbols subfield 716. The RSRP resolution subfield 712 indicates a resolution of RSRP values that can be reported by the UE, such as a 0.5 dBm resolution or a 1 dBm resolution, as illustrative examples. The number of resource blocks subfield 714 indicates a number of resource blocks that the UE is capable of using to transmit a CSI report message. The number of symbols subfield 716 indicates a number of symbols that the UE is capable of using to transmit a CSI report message. Although the CSI report capability field 704 is shown in FIG. 7 as including three subfields, in other examples, the CSI report capability field 704 may include fewer than three subfields, more than three subfields, one or more different subfields than shown in FIG. 7, or a combination thereof.

The UL reference signal capability field 706 indicates one or more parameters associated with transmitting a UL reference signal by the UE using the LP transceiver. For example, the UL reference signal capability field 706 may include a reference signal bandwidth subfield 718, a reference signal subcarrier spacing (SCS) subfield 720, a maximum number of configurations subfield 722, and a transmitter type subfield 724. The reference signal bandwidth subfield 718 indicates a bandwidth of UL signals that can be transmitted by the UE using the LP transceiver. The bandwidth of the UL signals may depend on the size of the LP transceiver memory (or portion of a main memory used to store the predefined transmit signal samples), such that larger bandwidths signals are associated with larger memory footprints. The reference signal SCS subfield 720 indicates a SCS of UL signals that can be transmitted by the UE using the LP transceiver. The maximum number of configurations subfield 722 indicates a maximum number of UL reference signal configurations or types that can be supported by the UE (supporting a larger number of UL reference signal configurations is associated with a larger memory footprint). The transmitter type subfield 724 indicates a type of LP transmitter or transmission waveform supported by the UE. For example, the UE may support one or more types of LP transmitters or transmission waveforms, such as an OOK transmitter or OOK waveform, an OOK waveform overlaid with an OFDM sequence, an OFDM transmitter or OFDM waveform, or another type of LP transmitter or transmission waveform. In some implementations, an OOK transmitter may be capable of transmitting signals varying only in amplitude but not phase, but an OFDM transmitter may be capable of transmitting signals varying in both amplitude and phase. Although the UL reference signal capability field 706 is shown in FIG. 7 as including four subfields, in other examples, the UL reference signal capability field 706 may include fewer than four subfields, more than four subfields, one or more different subfields than shown in FIG. 7, or a combination thereof.

The LP scheduling request capability field 708 indicates one or more parameters associated with transmitting an LP scheduling request by the UE using the LP transceiver. For example, the LP scheduling request capability field 708 may include a time between consecutive transmissions subfield 726 and a post-WUS delay subfield 728. The time between consecutive transmissions subfield 726 indicates an LP scheduling request frequency that can be supported by the UE or a minimum time gap between successive LP scheduling request transmissions that can be supported by the UE. The post-WUS delay subfield 728 indicates a time period between activation of the LP transceiver and a time at which the LP transceiver is capable of performing wireless communications, also referred to as a “ramp up” period. Although the LP scheduling request capability field 708 is shown in FIG. 7 as including two subfields, in other examples, the LP scheduling request capability field 708 may include fewer than two subfields, more than two subfields, one or more different subfields than shown in FIG. 7, or a combination thereof.

The LP buffer status report capability field 710 indicates one or more parameters associated with transmitting an LP buffer status report by the UE using the LP transceiver. For example, the LP buffer status report capability field 710 may include a time between consecutive transmissions subfield 730 and a post-WUS delay subfield 732, similar to the time between consecutive transmissions subfield 726 and the post-WUS delay subfield 728, respectively. Although the LP buffer status report capability field 710 is shown in FIG. 7 as including two subfields, in other examples, the LP buffer status report capability field 710 may include fewer than two subfields, more than two subfields, one or more different subfields than shown in FIG. 7, or a combination thereof.

FIG. 8 is a block diagram illustrating an example of a multi-transceiver configuration 800 associated with an LP transceiver in accordance with the present disclosure. In some implementations, the configuration 800 includes or corresponds to the configuration 470 of FIG. 4. In some examples, the configuration 800 is an RRC message that is communicated via RRC signaling by a network node to a UE, such as the network node 105 and the UE 115, respectively.

In the example shown in FIG. 8, the configuration 800 includes a CSI report parameters field 802, a UL reference signal parameters field 804, and an LP scheduling request parameters field 806. In other examples, the configuration 800 may include fewer than three fields, more than three fields, one or more different fields than shown in FIG. 8, one or more of the fields 802-806 may be omitted, or a combination thereof.

The CSI report parameters field 802 indicates one or more transmit parameters that are to be used by the UE when transmitting an LP CSI report message using the LP transceiver. For example, the CSI report parameters field 802 may include a CSI resource configuration identifier (ID) subfield 810, a CSI report resources subfield 812, a report periodicity subfield 814, and a report quantity subfield 816. In some implementations, the CSI report parameters field 802 may also include a flag that indicates that the UE is to transmit a CSI report using the LP transceiver, which may also act as an instruction to pre-generate and store predefined UL transmission signal samples in an LP transceiver memory (or another location associated with storage of sample data for use by the LP transceiver). The CSI resource configuration ID subfield 810 indicates one or more IDs of one or more CSI-RSs to be measured to generate CSI measurements to be indicated by the CSI report message. The CSI report resources subfield 812 indicates one or more wireless resources, such as physical resource blocks, SCS, or a combination thereof, to be used by the UE to transmit the CSI report message. The report periodicity subfield 814 indicates a periodicity of the CSI report(s) to be transmitted by the UE. The report quantity subfield 816 indicates a number of CSI report messages to be transmitted by the UE for a configured time period.

Although the CSI report parameters field 802 is shown in FIG. 8 as including four subfields, in other examples, the CSI report parameters field 802 may include fewer than four subfields, more than four subfields, one or more different subfields than shown in FIG. 8, or a combination thereof. As a non-limiting example, in some implementations, the CSI report parameters field 802 may include one or more transmit parameters, such as one or more of the transmit parameters 472 of FIG. 4, that are associated with generation of the UL signal that represents the CSI report message. For example, the CSI report parameters field 802 may include one or more subfields that indicate a transmit parameter value associated with CSI messages, one or more transmit parameter values associated with one or more CSI values to be indicated by the CSI messages, one or more parameter values associated with CSI-RSs used to generate the CSI values, or a combination thereof.

In this example, the CSI report parameters field 802 may indicate one or more values of a first parameter that indicate whether an UL transmission signal is a CSI report message (or alternatively, that indicates one or more parameter values associated with CSI-RSs used to generate the CSI values, such as one or more synchronization signal block (SSB) IDs), one or more values of a second parameter that indicate which ranges of dBm are being reported by the CSI report message, other control information or parameters associated with the CSI report, or a combination thereof. In some examples, the first parameter may include or correspond to a root index value of a ZC sequence, a primitive polynomial of a m-sequence, an index value of another mathematical sequence, a first set of subcarriers, another parameter, or a combination thereof. Additionally, or alternatively, the second parameter may include or correspond to a cyclic shift of a ZC sequence, an m-sequence, or another mathematical sequence, a second set of subcarriers, another parameter, or a combination thereof.

The UL reference signal parameters field 804 indicates one or more transmit parameters that are to be used by the UE when transmitting a UL reference signal using the LP transceiver. For example, the UL reference signal parameters field 804 may include a reference signal bandwidth subfield 818, a reference signal SCS subfield 820, a transmission frequency subfield 822, a transmitter type subfield 824, and a reference signal type subfield 826. In some implementations, the UL reference signal parameters field 804 may also include a flag that indicates that the UE is to transmit a UL reference signal using the LP transceiver, which may also act as an instruction to pre-generate and store predefined UL transmission signal samples in an LP transceiver memory (or another location associated with storage of sample data for use by the LP transceiver).

The reference signal bandwidth subfield 818 indicates a bandwidth of the UL reference signal that is to be transmitted by the UE using the LP transceiver. The reference signal SCS subfield 820 indicates a SCS of the UL reference signal that is to be transmitted by the UE using the LP transceiver. The transmission frequency subfield 822 indicates a transmission frequency of the UL reference signal to be transmitted by the UE using the LP transceiver. The transmitter type subfield 824 indicates a type of LP transmitter or transmission waveform to be used by the UE when transmitting the UL reference signal using the LP transceiver. For example, the type may include an OOK transmitter or OOK waveform, an OOK waveform overlaid with an OFDM sequence, an OFDM transmitter or OFDM waveform, or another type of LP transmitter or transmission waveform. The reference signal type subfield 826 indicates a type of UL reference signal, such as an SRS, that is to be transmitted by the UE. Activation for transmission of the UL reference signal may be sent to the UE by the network node before the UE transitions into the LP mode or as part of a WUS (or other LP control signal) while the UE is operating in the LP mode. Although the UL reference signal parameters field 804 is shown in FIG. 8 as including five subfields, in other examples, the UL reference signal parameters field 804 may include fewer than five subfields, more than five subfields, one or more different subfields than shown in FIG. 8, or a combination thereof.

The LP scheduling request parameters field 806 indicates one or more transmit parameters that are to be used by the UE when transmitting an LP scheduling request using the LP transceiver. For example, the LP scheduling request parameters field 806 may include a scheduling request (SR) type subfield 828, a time between consecutive transmissions subfield 830, and a post-WUS delay subfield 832. In some implementations, the LP scheduling request parameters field 806 may also include a flag that indicates that the UE is to transmit an LP scheduling request using the LP transceiver, which may also act as an instruction to pre-generate and store predefined UL transmission signal samples in an LP transceiver memory (or another location associated with storage of sample data for use by the LP transceiver). The SR type subfield 828 indicates a type of LP scheduling request that is to be transmitted by the UE using the LP transceiver. For example, the type of LP scheduling request may include an LP scheduling request message or an LP buffer status report message that has no payload (or has a null value for the payload). The time between consecutive transmissions subfield 830 indicates a frequency, or a minimum time gap between successive transmissions, of LP scheduling requests that are to be transmitted by the UE using the LP transceiver. The post-WUS delay subfield 832 indicates a time period between activation of the LP transceiver and a time at which the LP transceiver is capable of performing wireless communications. Although the LP scheduling request parameters field 806 is shown in FIG. 8 as including three subfields, in other examples, the LP scheduling request parameters field 806 may include fewer than three subfields, more than three subfields, one or more different subfields than shown in FIG. 8, or a combination thereof.

FIG. 9 is a diagram illustrating an example 900 of selecting predetermined transmission signal samples for use in generating a UL transmission by a multi-transceiver UE in accordance with the present disclosure. The example 900 includes operations that may be performed by a UE, such as the UE 115 of FIGS. 1-4 or the UE 600 of FIG. 6.

In the example 900, an LP transceiver memory 902 stores predefined transmission signal samples that are generated by the UE during a normal operating mode using a transceiver to enable transmission of UL signals during an LP mode via an LP transceiver. In some examples, the LP transceiver memory 902 may include or correspond to the memory 404 of FIG. 4 (or a portion thereof) or the LP transceiver memory 612 of FIG. 6. The predefined transmission signal samples include multiple sets of samples that are each associated with a respective transmission signal that is generated and sampled using the transceiver during the normal operating mode. For example, the predefined transmission signal samples include a first set of samples 904 associated with a first transmission signal 912, a second set of samples 906 associated with a second transmission signal 914, a third set of samples 908 associated with a third transmission signal 916, and a fourth set of samples 910 associated with a fourth transmission signal 918.

In the example 900, the predefined transmission signals are to be used to communicate CSI report messages by the UE to a network node. Accordingly, various predefined signals having different parameters are generated and sampled, such that the various parameters of the predefined signals can be used to indicate information related to the CSI report. In the example 900 of FIG. 9, the predefined transmission signals are generated using ZC sequences that are each associated with a respective root sequence index (a first parameter) and a respective cyclic shift that is applied to the ZC sequence (a second parameter), and one or both of these parameter values may be different between the transmission signals 912-918. For example, the first transmission signal 912 may be associated with a root sequence index 920 that has a first index value (“1” in FIG. 9) and a cyclic shift 922 that has a first shift value (“1” in FIG. 9), the second transmission signal 914 may be associated with a root sequence index 924 that has the first index value and a cyclic shift 926 that has a second shift value (“2” in FIG. 9), the third transmission signal 916 may be associated with a root sequence index 928 that has a second index value (“2” in FIG. 9) and a cyclic shift 930 that has the second shift value, and the fourth transmission signal 918 may be associated with a root sequence index 932 that has the second index value and a cyclic shift 934 that has the second shift value. In other examples, the transmission signals 912-918 may be associated with different root sequence index values and/or different cyclic shift values.

The first and second parameters (the root sequence index values and the cyclic shift values, respectively) may be associated with or mapped to various parameter values or information associated with CSI report messages by CSI report parameters 940. The CSI report parameters 940 may be indicated by a configuration received by the UE, such as the configuration 470 of FIG. 4 or the configuration 800 of FIG. 8, and the CSI report parameters 940 may include or correspond to the transmit parameters 472 of FIG. 4. Although this example is described in the context of CSI report messaging by the UE, in other aspects, the concepts described with reference to FIG. 9 may be applied to other types of UL signaling from the UE, such as UL reference signals, LP scheduling requests, or LP buffer status reports, as non-limiting examples.

In the example 900 shown in FIG. 9, the root sequence index associated with a ZC sequence used to generate an UL transmission signal is used to indicate a synchronization signal block (SSB) resource index of an CSI-RS that is measured to generate an RSRP value by the UE using the LP transceiver, and the cyclic shift applied to the ZC sequence is used to indicate an RSRP range measured by the UE using the LP transceiver. In this example, the first index value is associated with a first SSB resource index (SSBRI) (“SSBRI 1” in FIG. 9), the second index value is associated with a second SSBRI (“SSBRI 2” in FIG. 9), the first shift value is associated with an RSRP range (0 dBm to −10 dBm), and the second shift value is associated with a second RSRP range (−10 dBm to −20 dBm). In other examples, the root sequence index values may be associated with different SSBRIs and/or the cyclic shift values may be associated with different RSRP ranges, which are indicated by the CSI report parameters 940. In some other embodiments, the parameters of the transmission signals 912-914 may be used to indicate other parameters or characteristics of the CSI report. As an example, in some implementations, the root sequence index values may be used to indicate a message type of a UL transmission by the UE. In such an example, the first index value may indicate a CSI report message, the second index value may indicate a UL reference signal, a third index value may indicate an LP scheduling request, and a fourth index value may indicate an LP buffer status report.

At a particular time while operating in the LP mode, the UE may perform one or more channel measurements to generate detected CSI measurements 942. In the example 900, the detected CSI measurements 942 include an RSRP measurement equal to −12 dBm of a CSI-RS associated with the first SSBRI. To transmit a UL signal to the network node that represents a CSI report message that indicates the detected CSI measurements 942, the UE determines a root sequence index value (a first parameter value) and a cyclic shift value (a second parameter value) in accordance with the CSI report parameters 940. For example, because the detected CSI measurements 942 are associated with the first SSBRI, the UE determines that a UL transmission to be sent is associated with the first index value based on the association between the first SSBRI and the first index value indicated by the CSI report parameters 940. Similarly, because the detected CSI measurements 942 include an RSRP value that is within the second RSRP range (−10 dBm to −20 dBm), the UE determines that the UL transmission to be sent is associated with the second shift value based on the association between the second RSRP range and the second shift value indicated by the CSI report parameters 940. Although an example of determining associations between two aspects of a CSI report and two parameters of a UL transmission signal is described, in other examples, associations between more than two aspects of a CSI report and parameters of the UL transmission signal or between a single aspect of a CSI report and a parameter of the UL transmission signal may be determined by the UE.

After determining the root sequence index value and the cyclic shift value that indicate the detected CSI measurements 942, the UE may access the LP transceiver memory 902 to select a set of samples that correspond to a transmission signal having the determined parameter values. For example, the UE may select the second set of samples 906 that corresponds to the second transmission signal 914 for which the root sequence index 924 is the first index value (that is associated with the first SSBRI) and the cyclic shift 926 is the second shift value (that is associated with the second RSRP range). The UE may use the LP transceiver to generate the second transmission signal 914 in accordance with the second set of samples 906 for transmission to the network node as a UL transmission signal. Because the LP transceiver generates the UL transmission signal using the second set of samples 906, instead of processing and generating the UL transmission signal without pre-stored samples, the LP transceiver is able to generate and send the UL transmission signal while consuming less power than if the UL transmission signal was generated and sent by the transceiver during the normal operating mode, thereby reducing power consumption of the UE and prolonging the battery life of the UE.

Although the operations of the example 900 of FIG. 9 are described for predefined transmission signals that are generated using ZC sequences, in other examples, similar operations may be performed for predefined signals that are generated using other mathematical sequences, such as an m-sequence. For example, instead of associating various SSBRIs with various root sequence indices of ZC sequences, the CSI report parameters 940 may associate the various SSBRIs with primitive polynomials associated with m-sequences used to generate the transmission signals 912-918. In such an example, the various RSRP ranges are associated with various cyclic shifts applied to the m-sequences.

Alternatively, the CSI report parameters 940 may associate the various SSBRIs and the various RSRP ranges with sets of subcarriers via which the transmission signals 912-918 are to be sent by the UE using the LP transceiver. For example, instead of associating various SSBRIs with various root sequence indices of ZC sequences, the CSI report parameters 940 may associate the various SSBRIs different subcarriers of a first set of subcarriers used to transmit the transmission signals 912-918. In such an example, the various RSRP ranges are associated with second subcarriers of a second set of subcarriers used to transmit the transmission signals 912-918. For example, each subcarrier of the second set of subcarriers may be associated with a different RSRP range. In other examples, different combinations of subcarriers of the second set of subcarriers may each correspond to a different RSRP range. In still other examples, other parameters can be indicated by sets of subcarriers. In some embodiments, a parameter having a multi-bit value may be represented the subcarriers of a set of subcarriers that are used to transmit the UL transmission signal, also referred to as which of the set of subcarriers are “active subcarriers”. For example, if the second set of subcarriers include six subcarriers, whether or not each subcarrier is active (to indicate a value of “1”) or is not active (the signal is not detected in this subcarrier, to indicate a value of “0”) can be used to collectively represent a six-bit value.

FIG. 10 is a ladder diagram of an example of operations 1000 that support transmission of a CSI report message by a multi-transceiver UE in accordance with the present disclosure. In some aspects, the operations 1000 are performed by the UE 115 and the network node 105 described with reference to FIGS. 1-4, or the UE 600 of FIG. 6.

The operations begin at 1002, in which the UE 115 enters into an active mode, also referred to as a normal operating mode. While operating in the active mode, the transceiver 414 may be active and the LP transceiver 416 may be powered down. The UE 115 may perform wireless communications using the transceiver 414 while operating in the active mode.

At 1004, the UE 115 sends a capability message to network node 105. For example, the UE 115 may send the capability message 478 via the transceiver 414. The capability message 478 may indicate one or more multi-transceiver UL signaling capabilities of the UE 115, such as a CSI report capability, a UL reference signal capability, an LP schedule request capability, or an LP buffer status report capability, as further described above with reference to FIG. 7. In this example, the capability message 478 indicates one or more CSI report message parameters.

At 1006, the network node 105 sends a configuration that is associated with the LP transceiver 416 to UE 115. For example, the network node may send the configuration 470 to the UE 115, and the UE 115 may receive the configuration 470 via the transceiver 414. The configuration 470 indicates the transmit parameters 472 that are configured for the UE 115 to enable transmission of one or more types of UL signaling during one or more WUS monitoring periods. Additional details of the configuration 470 are described above with reference to FIG. 8. In this example, the configuration 470 indicates one or more CSI report message parameters.

At 1008, the UE 115 transitions to an LP mode for a WUS monitoring period. For example, the UE 115 may deactivate or power down the transceiver 414 and activate the LP transceiver 416 for performing wireless communications while operating in the LP mode. The UE 115 may be configured to operate in the LP mode for a duration of a WUS monitoring period, unless the UE 115 receives a WUS from the network node 105 that instructs the UE 115 to transition to the active mode or the UE 115 determines to transition to the active mode. The WUS monitoring period may have a duration that is predefined at the UE 115 and the network node 105 or that is configured at the UE 115 by the network node 105, such as via RRC signaling. In some embodiments, the WUS monitoring period is defined in one or more wireless communication standards and is preconfigured at the UE 115 and the network node 105.

At 1010, the network node 105 sends one or more CSI-RSs to the UE 115. The network node 105 may send the CSI-RSs periodically, semi-statically, or on demand, and the UE 115 may be configured to perform channel measurements at the appropriate times using the configuration 470. In some examples, each of the CSI-RSs is associated with a respective indicator, such as a respective SSBRI or a respective CSI-RS resource index (CRI). At 1012, the UE 115 performs one or more channel measurements on the CSI-RSs using the LP transceiver 416. For example, the UE 115 may monitor, via the LP transceiver 416, one or more wireless channels for the one or more CSI-RSs from the network node 105 and perform one or more channel measurements on the received CSI-RSs.

At 1014, the UE 115 sends a CSI report message via the LP transceiver to the network node 105. For example, the UE 115 may send the UL transmission signal 474 via the LP transceiver 416, and parameters of the UL transmission signal 474 may indicate the UL data/control information 476 associated with a CSI report message. For example, similar to as described with reference to FIG. 9, the UE 115 may select a set of the predefined transmission signal samples 406 having parameter values that are associated with parameters or the UL data/control information 476 of the CSI report message to be sent in accordance with the transmit parameters 472, and the UE 115 may generate and transmit the UL transmission signal 474 using the selected set of predefined transmission signal samples. In some examples, the UE 115 periodically sends the UL transmission signal 474 as a CSI report message or the UE 115 sends the UL transmission signal 474 as a CSI report message upon transitioning into the LP mode. Alternatively, the network node 105 may send a WUS signal to the UE 115 to request the UE 115 to send the UL transmission signal 474 as a CSI report.

In some examples, the UL transmission signal 474 that is sent as a CSI report message includes or indicates one or more indicators of the measured CSI-RSs and one or more respective RSRP values or ranges. For example, the UL transmission signal 474 may indicate a CRI and an RSRP value or range that is measured by the LP transceiver 416 from the CSI-RS in the indicated CRI. As another example, the UL transmission signal 474 may indicate a SSBRI and an RSRP value or range that is measured by the LP transceiver 416 from a reference signal in the SSB in the indicated SSBRI. In these examples, the CSI measurements that are performed, and the limited information that is indicated by the CSI report message, are capable of being performed, generated, and/or transmitted using the LP transceiver 416, as described above. In contrast, a typical CSI report message that is transmitted via the transceiver 414 in one or more PUCCH resources and while the UE 115 is operating in the active mode may include additional information as well as the information indicated by the UL transmission signal 474. For example, the CSI report sent via the transceiver 414 during the active mode may include or indicate one or more CRIs, one or more rank indicators, one or more channel quality indicators, one or more precoding matrix indicators, one or more layer indicators, one or more RSRP measurements, one or more SSBRIs, or a combination thereof.

At 1016, the network node 105 sends a WUS to the UE 115 in accordance with the CSI report message. For example, the network node 105 may send the WUS 480 to the UE 115, and the UE 115 may receive the WUS 480 via the LP transceiver 416. The network node 105 may use the received CSI report message represented by the UL transmission signal 474 to determine one or more DL transmission parameters, including a modulation and coding scheme (MCS), a channel coding rate, a selected transmit beam, or a combination thereof, and the network node 105 may send the WUS 480 in accordance with the determined DL transmission parameters. By providing the CSI report message to the network node 105 during the WUS monitoring period, the UE 115 enables the network node 105 to change a transmit beam, or other DL transmission parameters, used to transmit the WUS 480 to the UE 115 such that UE 115 can stay in a WUS coverage area while the UE 115 is in motion. Additionally, or alternatively, the WUS 480 may indicate one or more updated receive parameters, and the UE 115 may change one or more current receive parameters in accordance with the updated receive parameters. For example, the UE 115 may change a receive transmission configuration indication (TCI) state and/or a spatial relation parameter used to receive signaling from the network node 105 while the UE 115 is operating in the LP mode.

FIG. 11 is a ladder diagram of an example of operations 1100 that support transmission of an LP scheduling request message by a multi-transceiver UE in accordance with the present disclosure. In some aspects, the operations 1100 are performed by the UE 115 and the network node 105 described with reference to FIGS. 1-4 or the UE 600 described with reference to FIG. 6.

The operations begin at 1102, in which the UE 115 enters into an active mode, as described above with reference to FIG. 10. At 1104, the UE 115 sends a capability message via the transceiver 414 to the network node 105. For example, the UE 115 may send the capability message 478 via the transceiver 414. The capability message 478 may indicate one or more multi-transceiver UL signaling capabilities of the UE 115, such as a CSI report capability, a UL reference signal capability, an LP schedule request capability, or an LP buffer status report capability. In this example, the capability message 478 indicates one or more LP scheduling request capabilities, such as an LP transceiver capability, an LP scheduling request capability associated with the LP transceiver 416, a buffer status report capability associated with the LP transceiver 416, a transition duration to transition the transceiver 414 from a powered-down mode to an active mode, or a combination thereof, as further described above with reference to FIG. 7.

At 1106, the network node 105 sends a configuration that is associated with the LP transceiver 416 to UE 115. For example, the network node may send the configuration 470 to the UE 115, and the UE 115 may receive the configuration 470 via the transceiver 414. The configuration 470 indicates the transmit parameters 472 that are configured for the UE 115 to enable transmission of one or more types of UL signaling during one or more WUS monitoring periods. Additional details of the configuration 470 are described above with reference to FIG. 8. In this example, the configuration 470 indicates one or more LP scheduling request parameters, such as a UL transmission type, a cyclic shift, a time period between consecutive UL transmissions via the LP transceiver 416, a delay period after transmission of a WUS, or a combination thereof.

At 1108, the UE 115 transitions to an LP mode for a WUS monitoring period, as described above with reference to FIG. 10. At 1110, the UE 115 detects UL data for transmission to the network node 105. For example, an application being executed by the UE 115 may generate data or control information that is to be sent to the network node 105.

At 1112, the UE 115 sends an LP scheduling request via the LP transceiver 416 to the network node 105. For example, the UE 115 may send the UL transmission signal 474 via the LP transceiver 416, and parameters of the UL transmission signal 474 may indicate that the UL transmission signal 474 is an LP scheduling request. For example, similar to as described with reference to FIG. 9, the UE 115 may select a set of the predefined transmission signal samples 406 having parameter values that are associated with parameters of the LP scheduling request to be sent in accordance with the transmit parameters 472, and the UE 115 may generate and transmit the UL transmission signal 474 using the selected set of predefined transmission signal samples.

In some examples, the UL transmission signal 474 includes an explicit indication that the UE 115 is requesting the network node 105 to schedule UL resources and send an instruction to the UE 115 to transition to the active mode, such as a WUS or a “WUS like” signal that can be received and decoded by the LP transceiver 416 without performing frequence demodulation. For example, the explicit indication may include or correspond to a control bit that indicates the UE 115 is requesting a WUS or similar response. In some other examples, the UL transmission signal 474 includes an implicit indication that the UE 115 is requesting the network node 105 to schedule UL resources and send the instruction to the UE 115 to transition to the active mode. For example, the implicit indication may include or correspond to the UL transmission signal 474 being associated with a different cyclic shift than a scheduling request that is sent during the active mode via the transceiver 414 and within a PUCCH having format 0.

At 1114, the network node 105 sends a WUS via the LP transceiver 416 to the UE 115. For example, the UE 115 may monitor, via the LP transceiver 416, one or more wireless channels during a WUS monitoring period, and the network node 105 may send the WUS 480 to the UE 115 during the WUS monitoring period. The UE 115 may receive the WUS 480 via the LP transceiver 416 during the WUS monitoring period, and in some embodiments, before expiration of a time period, as further described herein with reference to FIG. 12. The WUS 480 may include or indicate an instruction for the UE 115 to “wake up”, such as by transitioning into the active mode, and to monitor a PDCCH for an upcoming resource grant.

At 1116, the UE 115 transitions to an active mode. For example, the UE 115 may activate or transition the transceiver 414 from a powered-down mode to an active mode responsive to receiving the WUS 480, and the UE 115 may deactivate or power down the LP transceiver 416 responsive to receiving the WUS 480. In some examples, transitioning from the LP mode to the active mode includes a “ramp up” period associated with the time it takes for the transceiver 414 to be powered on. During this ramp up period, the network node 105 abstains from sending any resource grant to the UE 115.

At 1118, the network node 105 sends a UL grant in a PDCCH to the UE 115. For example, after a post-WUS delay corresponding to the ramp up period, the network node 105 transmits a UL grant included in a PDCCH. After the transceiver 414 is powered on, the UE monitors, via the transceiver 414, one or more wireless channels to receive control information from the network node 105, and during the monitoring, the UE 115 receives the UL grant via the transceiver 414. Responsive to receiving the UL grant, the UE 115 may transmit the detected UL data via the transceiver to the network node 105 using one or more wireless resources indicated by the UL grant.

FIG. 12 is a ladder diagram of an example of operations 1200 that support transmission of an LP scheduling request message by a multi-transceiver UE in accordance with the present disclosure. In aspects, the operations 1200 are performed by the UE 115 and the network node 105 described with reference to FIGS. 1-4 or the UE 600 described with reference to FIG. 6.

The operations begin at 1202, in which the UE 115 enters into an active mode, as described above with reference to FIG. 10. At 1204, the UE 115 sends a capability message via the transceiver 414 to the network node 105. For example, the UE 115 may send the capability message 478 via the transceiver 414. The capability message 478 may indicate one or more multi-transceiver UL signaling capabilities of the UE 115, such as a CSI report capability, a UL reference signal capability, an LP schedule request capability, or an LP buffer status report capability. In this example, the capability message 478 indicates one or more LP scheduling request capabilities, such as an LP transceiver capability, an LP scheduling request capability associated with the LP transceiver 416, a buffer status report capability associated with the LP transceiver 416, a transition duration to transition the transceiver 414 from a powered-down mode to an active mode, or a combination thereof, as further described above with reference to FIG. 7.

At 1206, the network node 105 sends a configuration that is associated with the LP transceiver 416 to UE 115. For example, the network node may send the configuration 470 to the UE 115, and the UE 115 may receive the configuration 470 via the transceiver 414. The configuration 470 indicates the transmit parameters 472 that are configured for the UE 115 to enable transmission of one or more types of UL signaling during one or more WUS monitoring periods. Additional details of the configuration 470 are described above with reference to FIG. 8. In this example, the configuration 470 indicates one or more LP scheduling request parameters, such as a UL transmission type, a cyclic shift, a time period between consecutive UL transmissions via the LP transceiver 416, a delay period after transmission of a WUS, or a combination thereof.

At 1208, the UE 115 transitions to an LP mode for a WUS monitoring period, as described above with reference to FIG. 10. At 1210, the UE 115 detects UL data for transmission to the network node 105, as described above with reference to FIG. 11.

At 1212, the UE 115 sends an LP scheduling request message via the LP transceiver 416 to the network node 105. For example, the UE 115 may send the UL transmission signal 474 via the LP transceiver 416, and parameters of the UL transmission signal 474 may indicate that the UL transmission signal 474 is an LP scheduling request. For example, similar to as described with reference to FIG. 9, the UE 115 may select a set of the predefined transmission signal samples 406 having parameter values that are associated with parameters of the LP scheduling request to be sent in accordance with the transmit parameters 472, and the UE 115 may generate and transmit the UL transmission signal 474 using the selected set of predefined transmission signal samples. In some examples, the UL transmission signal 474 includes an explicit indication or an implicit indication that the UE 115 is requesting the network node 105 to schedule UL resources and send an instruction to the UE 115 to transition to the active mode, as described above with reference to FIG. 11.

At 1214, a wait time transpires without the UE 115 receiving a WUS from the network node 105. The wait time may be tracked by a time configured by the UE 115 to measure a duration of a configured time between consecutive LP scheduling request transmissions, which may be indicated by the time between consecutive transmissions subfield 830 of FIG. 8. The wait time may be configured by the network node 105 to prevent the UE 115 from transmitting too many LP scheduling requests to the network node 105.

At 1216, the UE 115 sends another SR message via the LP transceiver 416 to the network node 105. For example, the UE 115 may retransmit the UL transmission signal 474 via the LP transceiver 416 to the network node 105 to indicate another LP scheduling request. In some implementations, prior to retransmitting the UL transmission signal 474, the UE 115 may compare a count of consecutive UL transmissions associated with the LP scheduling request to a threshold number of transmissions and, if the count fails to satisfy the threshold, the UE 115 may retransmit the UL transmission signal 474 via the LP transceiver 416. In the example shown in FIG. 12, the threshold is three, and because the count is at one after the UE 115 transmits the UL transmission signal at 1212, the count fails to satisfy the threshold and the UE 115 determines to retransmit the UL transmission signal 474.

At 1217, another wait time transpires without the UE 115 receiving a WUS from the network node 105, similar to as described at 1215. At 1218, the UE 115 sends another SR message via the LP transceiver 416 to the network node 105.

At 1220, the UE 115 determines that a count satisfies at threshold value. For example, the UE 115 may retransmit the UL transmission signal 474 via the LP transceiver 416 to the network node 105 to indicate another LP scheduling request. As described above, prior to retransmitting the UL transmission signal 474, the UE 115 may compare the count of consecutive UL transmissions associated with the LP scheduling request to the threshold number of transmissions to determine whether to retransmit the UL transmission signal 474. Because the count is now two after the UE 115 transmits the UL transmission signal 474 at 1212 and retransmits the UL transmission signal 474 at 1216, the count fails to satisfy the threshold and the UE 115 determines to retransmit the UL transmission signal 474 another time.

At 1220, the UE 115 determines that the count of consecutive UL transmissions satisfies the threshold. For example, after another instance of the wait time transpires, the count is now three due to the transmission of the UL transmission signal 474 at 1212, 1216, and 1218, and thus the count now satisfies the threshold (three, in this example). In accordance with the count of consecutive UL transmissions satisfying the threshold number of transmissions, the UE 115 determines to transition to the active mode because the network node 105 may be unable to receive UL transmissions sent via the LP transceiver 416 due to channel conditions or other situations.

At 1222, the UE 115 transitions to the active mode, as described above with reference to FIG. 11, which includes activating the transceiver 414 and deactivating or powering down the LP transceiver 416. At 1224, the UE 115 sends, via the transceiver 414, another SR message to the network node 105. For example, after the ramp up period, the UE 115 may retransmit the UL transmission signal 474 via the transceiver 414 to the network node 105. Alternatively, the UE 115 may send a typical scheduling request message, instead of the LP scheduling request represented by the UL transmission signal 474. At 1226, the network node 105 sends a UL grant included in a PDCCH to the UE 115, and the UE 115 receives the UL grant via the transceiver 414, as described above with reference to FIG. 11.

Although FIGS. 11-12 describe examples of the UE 115 transmitting an LP scheduling request, in other implementations, the operations described with reference to FIGS. 11-12 may be performed to enable the UE 115 to transmit an LP buffer status report. For example, instead of the UL transmission signal 474 indicating an LP scheduling request, the UL transmission signal 474 may indicate an LP buffer status report, such as a buffer status report that indicates an empty buffer or that includes a null payload (or no payload). In such implementations, the network node 105 may be configured to identify an LP buffer status report as an implicit indication of a request to schedule UL resources by the UE 115, and the network node 105 may perform the operations described above to send the UL grant to the UE 115.

FIG. 13 is a flow diagram illustrating an example process 1300 that supports UL signal transmission by a multi-transceiver device in accordance with the present disclosure. Operations of the process 1300 may be performed by a UE, such as the UE 115 described above with reference to FIGS. 1-4 and 10-12 or the UE 600 as described above with reference to FIG. 6. For example, example operations (also referred to as “blocks”) of the process 1300 may enable the UE to perform UL signal transmission by a multi-transceiver device, according to some aspects of the present disclosure.

FIG. 14 is a block diagram of an example UE 1400 that supports UL signal transmission by a multi-transceiver device in accordance with the present disclosure. The UE 1400 may be configured to perform operations, including the blocks of the process 1300 described with reference to FIG. 13, to perform UL signal transmission by a multi-transceiver device. In some implementations, the UE 1400 includes the structure, hardware, and components shown and described with reference to the UE 115 of FIGS. 1-4 and 10-12 or the UE 600 of FIG. 6. For example, the UE 1400 includes the controller 280, which operates to execute logic or computer instructions stored in the memory 282, as well as controlling the components of the UE 1400 that provide the features and functionality of the UE 1400. The UE 1400, under control of the controller 280, transmits and receives signals via a primary transceiver 1401 and a secondary transceiver 1402 and the antennas 252a-r. The primary transceiver 1401 and the secondary transceiver 1402 include various components and hardware, as illustrated in FIG. 2 for the UE 115, including the modems 254a-r, the MIMO detector 256, the receive processor 258, the transmit processor 264, and the TX MIMO processor 266. In some embodiments, the primary transceiver 1401 includes or corresponds to the transceiver 414 of FIG. 4 or the main transceiver 602 of FIG. 6, and the secondary transceiver 1402 includes or corresponds to the LP transceiver 416 of FIG. 4 or the LP transceiver 610 of FIG. 6. The UE 1400 may be configured to perform wireless communications during a normal operating mode using the primary transceiver 1401 and to perform wireless communications during a LP mode using the secondary transceiver 1402.

As shown, the memory 282 may include the multi-transceiver wakeup manager 150 and predefined transmission signal samples 1403. Although illustrated in FIG. 14 as being included in the memory 282, in other implementations, the multi-transceiver wakeup manager 150 may be a separate component of the UE 1400. The multi-transceiver wakeup manager 150 may be configured to manage one or more operations supporting UL signal transmission by a multi-transceiver device, such as transmitting, via the secondary transceiver 1402 and during a WUS monitoring period, a UL transmission signal using a set of samples selected, in accordance with one or more transmit parameters, from the predefined transmission signal samples 1403. The predefined transmission signal samples 1403 may include or correspond to the predefined transmission signal samples 406 of FIG. 4 and/or the sets of samples 904-910 of FIG. 9. The UE 1400 may receive signals from or transmit signals to one or more network nodes, such as the network node 105 of FIGS. 1-4 and 10-12 or a network node as illustrated in FIG. 16.

Referring back to the process 1300 of FIG. 13, in block 1302, the UE 1400 receives, from a network node via a primary transceiver, a configuration associated with a secondary transceiver. For example, the configuration may include or correspond to the configuration 470 of FIG. 4 or the configuration 800 of FIG. 8. The configuration indicates one or more transmit parameters associated with the secondary transceiver and a WUS monitoring period. For example, the one or more transmit parameters may include or correspond to the transmit parameters 472 of FIG. 4 or the CSI report parameters 940 of FIG. 9.

In block 1304, the UE 1400 transmits, via the secondary transceiver, to the network node and during the WUS monitoring period, a UL transmission signal selected, in accordance with the one or more transmit parameters, from one or more predefined transmission signals. For example, the UL transmission signal may include or correspond to the UL transmission signal 474 of FIG. 4, and the one or more predefined transmission signals (or samples thereof) may include or correspond to the predefined transmission signal samples 406 of FIG. 4 or the sets of samples 904-910 of FIG. 9. In some implementations, each of the one or more predefined transmission signals is capable of being decoded without frequency demodulation at a receiver.

In some implementations, the process 1300 also includes transmitting, via the primary transceiver, to the network node and prior to reception of the configuration, a capability message that indicates a secondary transceiver capability, a CSI report capability associated with the secondary transceiver, a UL reference signal capability associated with the secondary transceiver, an LP scheduling request capability associated with the secondary transceiver, an LP buffer status report capability associated with the secondary transceiver, or a combination thereof. For example, the capability message may include or correspond to the capability message 478 of FIG. 4 and, in some implementations, the capability message may include the fields 702-710 of the UE capability message 700 of FIG. 7. The CSI report capability may indicate an RSRP resolution supported by the UE, a number of resource blocks associated with a CSI report message, a number of symbols associated with the CSI report message, or a combination thereof, as described with reference to the subfields 712-716 of FIG. 7. The UL reference signal capability may indicate a reference signal bandwidth supported by the UE, a reference signal subcarrier spacing supported by the UE, a maximum number of reference signal configurations supported by the UE, a transmitter type associated with the UE, or a combination thereof, as described with reference to subfields 718-724 of FIG. 7. The LP scheduling request capability or the LP buffer status report capability may indicate a time period between consecutive UL transmissions via the secondary transceiver, a delay period after transmission of a WUS, or a combination thereof, as described with reference to the subfields 726-728 of FIG. 7.

In some implementations, the UL transmission signal indicates a CSI report message, and the one or more transmit parameters include a CSI resource configuration ID associated with the CSI report message, one or more wireless resources associated with the CSI report message, a periodicity associated with the CSI report message, a report quantity associated with the CSI report message, or a combination thereof. For example, the UL transmission signal 474 may indicate a CSI report message, and the transmit parameters 472 may include one or more parameters indicated by the subfields 810-816 of FIG. 8. In some such implementations, the process 1300 also includes monitoring, via the secondary transceiver, one or more wireless channels for one or more CSI-RSs from the network node, the one or more CSI-RSs associated with one or more indicators, as described with reference to FIG. 10. The one or more indicators include one or more CSI-RS resource indicators or one or more SSB resource indicators or one or more CRIs. Additionally, the CSI report message includes the one or more indicators and one or more respective RSRP values in accordance with the one or more CSI reference signals, as described with reference to FIGS. 9-10.

In some implementations, the UL transmission signal is a UL reference signal, and the one or more transmit parameters include a bandwidth associated with the UL reference signal, a subcarrier spacing associated with the UL reference signal, a transmission frequency associated with the UL reference signal, a transmitter type, a reference signal type associated with the UL reference signal, or a combination thereof. For example, the UL transmission signal 474 may be a UL reference signal, and the transmit parameters 472 may include one or more parameters indicated by the subfields 818-826 of FIG. 8.

In some implementations, the UL transmission signal indicates an LP scheduling request or an LP buffer status report, and the process 1300 also includes monitoring, via the secondary transceiver, one or more wireless channels for a WUS during the WUS monitoring period, receiving the WUS during the monitoring period, transitioning the primary transceiver from a powered-down mode to an active mode responsive to the WUS, and monitoring, via the primary transceiver, the one or more wireless channels for an uplink grant message included in a PDCCH from the network node, as described above with reference to FIG. 11.

In some implementations, the UL transmission signal indicates an LP scheduling request, and the process 1300 also includes transmitting, via the secondary transceiver, to the network node and during the WUS monitoring period, another UL transmission signal that indicates the LP scheduling request, transitioning the primary transceiver from a powered-down mode to an active mode in accordance with a count of consecutive UL transmission signals that indicate scheduling requests satisfying a threshold number of signals, and transmitting, via the primary transceiver, to the network node, the UL transmission signal after transitioning to the active mode, as described above with reference to FIG. 12.

In some implementations, the process 1300 also includes receiving, from the network node via the secondary transceiver, a DL control signal during the WUS monitoring period. The DL control signal indicates one or more updated values of the one or more transmit parameters, an instruction to send the UL transmission signal, or a combination thereof. For example, the DL control signal may include or correspond to the WUS 480 of FIG. 4.

FIG. 15 is a flow diagram illustrating an example process 1500 that supports configuring UL signal transmission for a multi-transceiver device in accordance with the present disclosure. Operations of the process 1500 may be performed by a network node, such as the network node 105 described above with reference to FIGS. 1-4 and 10-12. For example, example operations of the process 1500 may enable a network node to configure UL signal transmission for a multi-transceiver device.

FIG. 16 is a block diagram of an example network node 1600 that supports configuring UL signal transmission for a multi-transceiver device in accordance with the present disclosure. The network node 1600 may be configured to perform operations, including the blocks of the process 1500 described with reference to FIG. 15, to configure UL signal transmission for a multi-transceiver device. In some implementations, the network node 1600 includes the structure, hardware, and components shown and described with reference to the network node 105 of FIGS. 1-4 and 10-12. For example, the network node 1600 may include the controller 240, which operates to execute logic or computer instructions stored in the memory 242, as well as controlling the components of the network node 1600 that provide the features and functionality of the network node 1600. The network node 1600, under control of the controller 240, transmits and receives signals via wireless radios 1601 and the antennas 234a-t. The wireless radios 1601 include various components and hardware, as illustrated in FIG. 2 for the network node 105, including the modems 232a-t, the transmit processor 220, the TX MIMO processor 230, the MIMO detector 236, and the receive processor 238.

As shown, the memory 242 may include the multi-transceiver wakeup manager 152 and transmit parameters 1602. Although illustrated in FIG. 16 as being included in the memory 242, in other implementations, the multi-transceiver wakeup manager 152 may be a separate component of the network node 1600. The multi-transceiver wakeup manager 152 may be configured to manage one or more operations supporting configuration of UL signal transmission for a multi-transceiver device, such as transmitting a configuration indicating one or more transmit parameters associated with a secondary transceiver of a UE and a WUS monitoring period. The transmit parameters 1602 may include or correspond to the transmit parameters 472 of FIG. 4. The network node 1600 may receive signals from or transmit signals to one or more UEs, such as the UE 115 of FIGS. 1-4 and 10-12, the UE 600 of FIG. 6, or the UE 1400 of FIG. 14.

Referring back to the process 1500 of FIG. 15, in block 1502, the network node 1600 transmits, to a UE that includes a primary transceiver and a secondary transceiver, a configuration associated with the secondary transceiver of the UE. For example, the configuration may include or correspond to the configuration 470 of FIG. 4 or the configuration 800 of FIG. 8. The configuration indicates one or more transmit parameters associated with the secondary transceiver and a WUS monitoring period. For example, the one or more transmit parameters may include or correspond to the transmit parameters 472 of FIG. 4 or the CSI report parameters 940 of FIG. 9.

In block 1504, the network node 1600 receives, from the UE and during the WUS monitoring period, a UL transmission signal in accordance with the one or more transmit parameters, the UL transmission signal included in one or more predefined transmission signals. For example, the UL transmission signal may include or correspond to the UL transmission signal 474 of FIG. 4, and the one or more predefined transmission signals (or samples thereof) may include or correspond to the predefined transmission signal samples 406 of FIG. 4 or the sets of samples 904-910 of FIG. 9.

In some implementations, the process 1500 also includes determining one or more DL transmit parameters in accordance with the UL transmission signal, and transmitting, to the UE and in accordance with the one or more DL transmit parameters, a WUS during the WUS monitoring period. For example, the WUS may include or correspond to the WUS 480 of FIG. 4, and the DL transmit parameters may be determined as described above with reference to FIG. 4 and FIG. 10.

In some implementations, the process 1300 also includes receiving, from the UE and prior to transmission of the configuration, a capability message that indicates a secondary transceiver capability, a CSI report capability associated with the secondary transceiver, an UL reference signal capability associated with the secondary transceiver, an LP scheduling request capability associated with the secondary transceiver, an LP buffer status report capability associated with the secondary transceiver, or a combination thereof. For example, the capability message may include or correspond to the capability message 478 of FIG. 4 and, in some implementations, the capability message may include the fields 702-710 of the UE capability message 700 of FIG. 7. The CSI report capability may indicate an RSRP resolution supported by the UE, a number of resource blocks associated with a CSI report message, a number of symbols associated with the CSI report message, or a combination thereof, as described with reference to the subfields 712-716 of FIG. 7. The UL reference signal capability may indicate a reference signal bandwidth supported by the UE, a reference signal subcarrier spacing supported by the UE, a maximum number of reference signal configurations supported by the UE, a transmitter type associated with the UE, or a combination thereof, as described with reference to subfields 718-724 of FIG. 7. The LP scheduling request capability or the LP buffer status report capability may indicate a time period between consecutive UL transmissions via the secondary transceiver, a delay period after transmission of a WUS, or a combination thereof, as described with reference to the subfields 726-728 of FIG. 7.

In some implementations, the UL transmission signal indicates a CSI report message, and the one or more transmit parameters include a CSI resource configuration ID associated with the CSI report message, one or more wireless resources associated with the CSI report message, a periodicity associated with the CSI report message, a report quantity associated with the CSI report message, or a combination thereof. For example, the UL transmission signal 474 may indicate a CSI report message, and the transmit parameters 472 may include one or more parameters indicated by the subfields 810-816 of FIG. 8. In some such implementations, the CSI report message includes one or more RSRP values associated with one or more CSI-RS resource indicators or one or more SSB resource indicators, as described with reference to FIGS. 9-10.

In some implementations, the UL transmission signal includes a UL reference signal, and the one or more transmit parameters include a bandwidth associated with the UL reference signal, a subcarrier spacing associated with the UL reference signal, a transmission frequency associated with the UL reference signal, a transmitter type, a reference signal type associated with the UL reference signal, or a combination thereof. For example, the UL transmission signal 474 may be a UL reference signal, and the transmit parameters 472 may include one or more parameters indicated by the subfields 818-826 of FIG. 8.

In some implementations, the UL transmission indicates an LP scheduling request or an LP buffer status report, and the process 1500 also includes transmitting, to the UE and in accordance with receipt of the LP scheduling request or the LP buffer status report, a WUS during the WUS monitoring period and transmitting, to the UE, an uplink grant message included in a PDCCH, as described above with reference to FIG. 11.

It is noted that one or more blocks (or operations) described with reference to FIGS. 13 and 15 may be combined with one or more blocks (or operations) described with reference to another of the figures. For example, one or more blocks (or operations) of FIG. 13 may be combined with one or more blocks (or operations) of FIG. 15. As another example, one or more blocks associated with FIG. 13 or 15 may be combined with one or more blocks (or operations) associated with FIGS. 1-12. Additionally, or alternatively, one or more operations described above with reference to FIGS. 1-12 may be combined with one or more operations described with reference to FIG. 14 or 16.

In the following, further examples are described to facilitate the understanding of the disclosure.

According to Example 1, a UE for wireless communication includes: a processing system that includes one or more processors and one or more memories that store code and are coupled with the one or more processors. The processing system is configured to cause the UE to receive, from a network node via a primary transceiver, a configuration associated with a secondary transceiver. The configuration indicates one or more transmit parameters associated with the secondary transceiver and a WUS monitoring period. The processing system is further configured to transmit, via the secondary transceiver, to the network node and during the WUS monitoring period, a UL transmission signal selected, in accordance with the one or more transmit parameters, from one or more predefined transmission signals.

Example 2 includes the UE of Example 1, where each of the one or more predefined transmission signals is capable of being decoded without frequency demodulation at a receiver.

Example 3 includes the UE of Example 1 or Example 2, where the processing system is further configured to cause the UE to: transmit, via the primary transceiver, to the network node and prior to reception of the configuration, a capability message that indicates a secondary transceiver capability, a CSI report capability associated with the secondary transceiver, an UL reference signal capability associated with the secondary transceiver, an LP scheduling request capability associated with the secondary transceiver, an LP buffer status report capability associated with the secondary transceiver, or a combination thereof. The CSI report capability indicates an RSRP resolution supported by the UE, a number of resource blocks associated with a CSI report message, a number of symbols associated with the CSI report message, or a combination thereof. The UL reference signal capability indicates a reference signal bandwidth supported by the UE, a reference signal subcarrier spacing supported by the UE, a maximum number of reference signal configurations supported by the UE, a transmitter type associated with the UE, or a combination thereof. The LP scheduling request capability or the LP buffer status report capability indicates a time period between consecutive UL transmissions via the secondary transceiver, a delay period after transmission of a WUS, or a combination thereof.

Example 4 includes the UE of any of Examples 1 to 3, where: the UL transmission signal indicates a CSI report message; and the one or more transmit parameters include a CSI resource configuration ID associated with the CSI report message, one or more wireless resources associated with the CSI report message, a periodicity associated with the CSI report message, a report quantity associated with the CSI report message, or a combination thereof.

Example 5 includes the UE of Example 4, where the processing system is further configured to: cause the UE to monitor, via the secondary transceiver, one or more wireless channels for one or more CSI-RSs from the network node, the one or more CSI-RSs associated with one or more indicators. The one or more indicators include one or more CSI-RS resource indicators or one or more SSB resource indicators. Additionally, the CSI report message includes the one or more indicators and one or more respective RSRP values in accordance with the one or more CSI reference signals.

Example 6 includes the UE of any of Examples 1 to 5, in which the UL transmission signal is a UL reference signal; and the one or more transmit parameters include a bandwidth associated with the UL reference signal, a subcarrier spacing associated with the UL reference signal, a transmission frequency associated with the UL reference signal, a transmitter type, a reference signal type associated with the UL reference signal, or a combination thereof.

Example 7 includes the UE of any of Examples 1 to 3, where: the UL transmission signal indicates an LP scheduling request or an LP buffer status report, and the processing system is further configured to cause the UE to monitor, via the secondary transceiver, one or more wireless channels for a WUS during the WUS monitoring period. Additionally, the processing system is configured to receive the WUS during the monitoring period. Further, the processing system is configured to transition the primary transceiver from a powered-down mode to an active mode responsive to the WUS. The processing system is further configured to monitor, via the primary transceiver, the one or more wireless channels for an uplink grant message included in a PDCCH from the network node.

Example 8 includes the UE of any of Examples 1 to 3, where: the UL transmission signal indicates an LP scheduling request; and the processing system is further configured to cause the UE to transmit, via the secondary transceiver, to the network node and during the WUS monitoring period, another UL transmission signal that indicates the LP scheduling request. Additionally, the processing system is configured to transition the primary transceiver from a powered-down mode to an active mode in accordance with a count of consecutive UL transmission signals that indicate scheduling requests satisfying a threshold number of signals; and transmit, via the primary transceiver, to the network node, the UL transmission signal after transitioning to the active mode.

Example 9 includes the UE of any of Examples 1 to 8, where the processing system is further configured to cause the UE to receive, from the network node via the secondary transceiver, a DL control signal during the WUS monitoring period. The DL control signal indicates one or more updated values of the one or more transmit parameters, an instruction to send the UL transmission signal, or a combination thereof.

According to Example 10, a method of wireless communication by a UE, includes: receiving, from a network node via a primary transceiver, a configuration associated with a secondary transceiver. The configuration indicates one or more transmit parameters associated with the secondary transceiver and a WUS monitoring period. The method further includes transmitting, via the secondary transceiver, to the network node and during the WUS monitoring period, a UL transmission signal selected, in accordance with the one or more transmit parameters, from one or more predefined transmission signals.

Example 11 includes the method of Example 10, in which each of the one or more predefined transmission signals is capable of being decoded without frequency demodulation at a receiver.

Example 12 includes the method of Example 10 or Example 11, in which the method further includes: transmitting, via the primary transceiver, to the network node and prior to reception of the configuration, a capability message that indicates a secondary transceiver capability, a CSI report capability associated with the secondary transceiver, an UL reference signal capability associated with the secondary transceiver, an LP scheduling request capability associated with the secondary transceiver, an LP buffer status report capability associated with the secondary transceiver, or a combination thereof. The CSI report capability indicates an RSRP resolution supported by the UE, a number of resource blocks associated with a CSI report message, a number of symbols associated with the CSI report message, or a combination thereof. The UL reference signal capability indicates a reference signal bandwidth supported by the UE, a reference signal subcarrier spacing supported by the UE, a maximum number of reference signal configurations supported by the UE, a transmitter type associated with the UE, or a combination thereof. The LP scheduling request capability or the LP buffer status report capability indicates a time period between consecutive UL transmissions via the secondary transceiver, a delay period after transmission of a WUS, or a combination thereof.

Example 13 includes the method of any of Examples 10 to 12, where: the UL transmission signal indicates a CSI report message; and the one or more transmit parameters include a CSI resource configuration ID associated with the CSI report message, one or more wireless resources associated with the CSI report message, a periodicity associated with the CSI report message, a report quantity associated with the CSI report message, or a combination thereof.

Example 14 includes the method of Example 13, and further includes: monitoring, via the secondary transceiver, one or more wireless channels for one or more CSI-RSs from the network node, the one or more CSI-RSs associated with one or more indicators. The one or more indicators include one or more CSI-RS resource indicators or one or more SSB resource indicators. The CSI report message includes the one or more indicators and one or more respective RSRP values in accordance with the one or more CSI reference signals.

Example 15 includes the method of any of Examples 10 to 12, where: the UL transmission signal is a UL reference signal. The one or more transmit parameters include a bandwidth associated with the UL reference signal, a subcarrier spacing associated with the UL reference signal, a transmission frequency associated with the UL reference signal, a transmitter type, a reference signal type associated with the UL reference signal, or a combination thereof.

Example 16 includes the method of any of Examples 10 to 12, where: the UL transmission signal indicates an LP scheduling request or an LP buffer status report. The method further includes monitoring, via the secondary transceiver, one or more wireless channels for a WUS during the WUS monitoring period. Further, the method includes receiving the WUS during the monitoring period and transitioning the primary transceiver from a powered-down mode to an active mode responsive to the WUS. Additionally, the method includes monitoring, via the primary transceiver, the one or more wireless channels for an uplink grant message included in a PDCCH from the network node.

Example 17 includes the method of any of Examples 10 to 12, where: the UL transmission signal indicates an LP scheduling request. The method further includes transmitting, via the secondary transceiver, to the network node and during the WUS monitoring period, another UL transmission signal that indicates the LP scheduling request. Additionally, the method includes transitioning the primary transceiver from a powered-down mode to an active mode in accordance with a count of consecutive UL transmission signals that indicate scheduling requests satisfying a threshold number of signals. Further, the method includes transmitting, via the primary transceiver, to the network node, the UL transmission signal after transitioning to the active mode.

Example 18 includes the method of any of Examples 10 to 17, and further includes: receiving, from the network node via the secondary transceiver, a DL control signal during the WUS monitoring period. The DL control signal indicates one or more updated values of the one or more transmit parameters, an instruction to send the UL transmission signal, or a combination thereof.

According to Example 19, a network node for wireless communication, includes: a processing system that includes one or more processors and one or more memories that store code and are coupled with the one or more processors. The processing system is configured to cause the network node to transmit, to a UE that includes a primary transceiver and a secondary transceiver, a configuration associated with the secondary transceiver of the UE. The configuration indicates one or more transmit parameters associated with the secondary transceiver and a WUS monitoring period. The processing system is further configured to receive, from the UE and during the WUS monitoring period, a UL transmission signal in accordance with the one or more transmit parameters, the UL transmission signal included in one or more predefined transmission signals.

Example 20 includes the network node of Example 19, where the processing system is further configured to cause the network node to: determine one or more DL transmit parameters in accordance with the UL transmission signal. Additionally, the processing system is configured to transmit, to the UE and in accordance with the one or more DL transmit parameters, a WUS during the WUS monitoring period.

Example 21 includes the network node of Example 19 or Example 20, where the processing system is further configured to cause the network node to: receive, from the UE and prior to transmission of the configuration, a capability message that indicates a secondary transceiver capability, a CSI report capability associated with the secondary transceiver, an UL reference signal capability associated with the secondary transceiver, an LP scheduling request capability associated with the secondary transceiver, an LP buffer status report capability associated with the secondary transceiver, or a combination thereof. The CSI report capability indicates an RSRP resolution supported by the UE, a number of resource blocks associated with a CSI report message, a number of symbols associated with the CSI report message, or a combination thereof. The UL reference signal capability indicates a reference signal bandwidth supported by the UE, a reference signal subcarrier spacing supported by the UE, a maximum number of reference signal configurations supported by the UE, a transmitter type associated with the UE, or a combination thereof. The LP scheduling request capability or the LP buffer status report capability indicates a time period between consecutive UL transmissions via the secondary transceiver, a delay period after transmission of a WUS, or a combination thereof.

Example 22 includes the network node of any of Examples 19 to 21, where: the UL transmission signal indicates a CSI report message. Further, the one or more transmit parameters include a CSI resource configuration ID associated with the CSI report message, one or more wireless resources associated with the CSI report message, a periodicity associated with the CSI report message, a report quantity associated with the CSI report message, or a combination thereof. Additionally, the CSI report message includes one or more RSRP values associated with one or more CSI-RS resource indicators or one or more SSB resource indicators.

Example 23 includes the network node of any of Examples 19 to 21, where: the UL transmission signal includes a UL reference signal. Additionally, the one or more transmit parameters include a bandwidth associated with the UL reference signal, a subcarrier spacing associated with the UL reference signal, a transmission frequency associated with the UL reference signal, a transmitter type, a reference signal type associated with the UL reference signal, or a combination thereof.

Example 24 includes the network node of any of Examples 19 to 21, where: the UL transmission signal indicates an LP scheduling request or an LP buffer status report. The processing system is further configured to cause the network node to transmit, to the UE and in accordance with receipt of the LP scheduling request or the LP buffer status report, a WUS during the WUS monitoring period. The processing system is further configured to cause the network node to transmit, to the UE, an uplink grant message included in a PDCCH.

According to Example 25, a method of wireless communication by a network node, includes: transmitting, to a UE that includes a primary transceiver and a secondary transceiver, a configuration associated with the secondary transceiver of the UE. The configuration indicates one or more transmit parameters associated with the secondary transceiver and a WUS monitoring period. The method further includes receiving, from the UE and during the WUS monitoring period, a UL transmission signal in accordance with the one or more transmit parameters, the UL transmission signal included in one or more predefined transmission signals.

Example 26 includes the method of Example 25, and further includes: determining one or more DL transmit parameters in accordance with the UL transmission signal. Additionally, the method includes transmitting, to the UE and in accordance with the one or more DL transmit parameters, a WUS during the WUS monitoring period.

Example 27 includes the method of Example 25 or Example 26, and further includes: receiving, from the UE and prior to transmission of the configuration, a capability message that indicates a secondary transceiver capability, a CSI report capability associated with the secondary transceiver, an UL reference signal capability associated with the secondary transceiver, an LP scheduling request capability associated with the secondary transceiver, an LP buffer status report capability associated with the secondary transceiver, or a combination thereof. The CSI report capability indicates an RSRP resolution supported by the UE, a number of resource blocks associated with a CSI report message, a number of symbols associated with the CSI report message, or a combination thereof. Additionally, the UL reference signal capability indicates a reference signal bandwidth supported by the UE, a reference signal subcarrier spacing supported by the UE, a maximum number of reference signal configurations supported by the UE, a transmitter type associated with the UE, or a combination thereof. Further, the LP scheduling request capability or the LP buffer status report capability indicates a time period between consecutive UL transmissions via the secondary transceiver, a delay period after transmission of a WUS, or a combination thereof.

Example 28 includes the method of any of Examples 25 to 27, where: the UL transmission signal indicates a CSI report message. Additionally, the one or more transmit parameters include a CSI resource configuration ID associated with the CSI report message, one or more wireless resources associated with the CSI report message, a periodicity associated with the CSI report message, a report quantity associated with the CSI report message, or a combination thereof. The CSI report message includes one or more RSRP values associated with one or more CSI-RS resource indicators or one or more SSB resource indicators.

Example 29 includes the method of any of Examples 25 to 27, where: the UL transmission signal includes a UL reference signal. Further, the one or more transmit parameters include a bandwidth associated with the UL reference signal, a subcarrier spacing associated with the UL reference signal, a transmission frequency associated with the UL reference signal, a transmitter type, a reference signal type associated with the UL reference signal, or a combination thereof.

Example 30 includes the method of any of Examples 25 to 27, where: the UL transmission signal indicates an LP scheduling request or an LP buffer status report. The method further includes transmitting, to the UE and in accordance with receipt of the LP scheduling request or the LP buffer status report, a WUS during the WUS monitoring period. Additionally, the method includes transmitting, to the UE, an uplink grant message included in a PDCCH.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-16 include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logics, logical blocks, modules, circuits, and algorithm processes described in connection with the disclosure herein may be implemented as electronic hardware, computer software, or combinations of both. To clearly illustrate this interchangeability of hardware and software, various illustrative components, blocks, modules, circuits, and processes have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include random access memory (RAM), read-only memory (ROM), electronically erasable programable ROM (EEPROM), compact disc (CD) ROM (CD-ROM), or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product or a computer-readable storage device.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted can be incorporated in the example processes that are schematically illustrated. For example, one or more additional operations can be performed before, after, simultaneously with, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, some other implementations are within the scope of the following claims. In some cases, the actions recited in the claims can be performed in a different order and still achieve desirable results.

As used herein, including in the claims, the term “or,” when used in a list of two or more items, means that any one of the listed items can be employed by itself, or any combination of two or more of the listed items can be employed. For example, if a composition is described as containing components A, B, or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. Such a threshold may be a single value or a range of values. As an illustrative example, a value may satisfy a threshold range of values if the value is greater than or equal to each of the threshold values included within the threshold range of values.

No element, act, or instruction used herein should be construed as critical or essential unless explicitly described as such. Also, as used herein, the articles “a” and “an” are intended to include one or more items and may be used interchangeably with “one or more.” It should be understood that “one or more” is equivalent to “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Similarly, the phrase “in accordance with” is intended to mean “based on or otherwise in association with” unless explicitly stated otherwise.

The previous description of the disclosure is provided to enable any person skilled in the art to make or use the disclosure. Various modifications to the implementations described in this disclosure may be readily apparent to those skilled in the art, and the generic principles defined herein may be applied to other variations without departing from the scope of this disclosure. Thus, the disclosure is not intended to be limited to the examples and designs described herein but is to be accorded the widest scope consistent with the principles and novel features disclosed herein.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
a processing system that includes one or more processors and one or more memories that store code and are coupled with the one or more processors, the processing system configured to cause the UE to:
receive, from a network node via a primary transceiver, a configuration associated with a secondary transceiver, the configuration indicating one or more transmit parameters associated with the secondary transceiver and a wake-up signal (WUS) monitoring period; and
transmit, via the secondary transceiver, to the network node and during the WUS monitoring period, an uplink (UL) transmission signal selected, in accordance with the one or more transmit parameters, from one or more predefined transmission signals.

2. The UE of claim 1, wherein each of the one or more predefined transmission signals is capable of being decoded without frequency demodulation at a receiver.

3. The UE of claim 1, wherein the processing system is further configured to cause the UE to:
transmit, via the primary transceiver, to the network node and prior to reception of the configuration, a capability message that indicates a secondary transceiver capability, a channel state information (CSI) report capability associated with the secondary transceiver, an UL reference signal capability associated with the secondary transceiver, a low-power (LP) scheduling request capability associated with the secondary transceiver, an LP buffer status report capability associated with the secondary transceiver, or a combination thereof,
wherein the CSI report capability indicates a reference signal received power (RSRP) resolution supported by the UE, a number of resource blocks associated with a CSI report message, a number of symbols associated with the CSI report message, or a combination thereof,
wherein the UL reference signal capability indicates a reference signal bandwidth supported by the UE, a reference signal subcarrier spacing supported by the UE, a maximum number of reference signal configurations supported by the UE, a transmitter type associated with the UE, or a combination thereof, or
wherein the LP scheduling request capability or the LP buffer status report capability indicates a time period between consecutive UL transmissions via the secondary transceiver, a delay period after transmission of a WUS, or a combination thereof.

4. The UE of claim 1, wherein:
the UL transmission signal indicates a channel state information (CSI) report message; and
the one or more transmit parameters include a CSI resource configuration identifier (ID) associated with the CSI report message, one or more wireless resources associated with the CSI report message, a periodicity associated with the CSI report message, a report quantity associated with the CSI report message, or a combination thereof.

5. The UE of claim 4, wherein the processing system is further configured to cause the UE to:
monitor, via the secondary transceiver, one or more wireless channels for one or more CSI reference signals (CSI-RSs) from the network node, the one or more CSI-RSs associated with one or more indicators, wherein the one or more indicators include one or more CSI-RS resource indicators or one or more synchronization signal block (SSB) resource indicators, and
wherein the CSI report message includes the one or more indicators and one or more respective reference signal received power (RSRP) values in accordance with the one or more CSI reference signals.

6. The UE of claim 1, wherein:
the UL transmission signal is a UL reference signal; and
the one or more transmit parameters include a bandwidth associated with the UL reference signal, a subcarrier spacing associated with the UL reference signal, a transmission frequency associated with the UL reference signal, a transmitter type, a reference signal type associated with the UL reference signal, or a combination thereof.

7. The UE of claim 1, wherein:
the UL transmission signal indicates a low-power (LP) scheduling request or an LP buffer status report; and
the processing system is further configured to cause the UE to:
monitor, via the secondary transceiver, one or more wireless channels for a WUS during the WUS monitoring period;
receive the WUS during the monitoring period;
transition the primary transceiver from a powered-down mode to an active mode responsive to the WUS; and
monitor, via the primary transceiver, the one or more wireless channels for an uplink grant message included in a physical downlink control channel (PDCCH) from the network node.

8. The UE of claim 1, wherein:
the UL transmission signal indicates a low-power (LP) scheduling request; and
the processing system is further configured to cause the UE to:
transmit, via the secondary transceiver, to the network node and during the WUS monitoring period, another UL transmission signal that indicates the LP scheduling request;
transition the primary transceiver from a powered-down mode to an active mode in accordance with a count of consecutive UL transmission signals that indicate scheduling requests satisfying a threshold number of signals; and
transmit, via the primary transceiver, to the network node, the UL transmission signal after transitioning to the active mode.

9. The UE of claim 1, wherein the processing system is further configured to cause the UE to:
receive, from the network node via the secondary transceiver, a downlink (DL) control signal during the WUS monitoring period, wherein the DL control signal indicates one or more updated values of the one or more transmit parameters, an instruction to send the UL transmission signal, or a combination thereof.

10. A method of wireless communication by a user equipment (UE), comprising:
receiving, from a network node via a primary transceiver, a configuration associated with a secondary transceiver, the configuration indicating one or more transmit parameters associated with the secondary transceiver and a wake-up signal (WUS) monitoring period; and
transmitting, via the secondary transceiver, to the network node and during the WUS monitoring period, an uplink (UL) transmission signal selected, in accordance with the one or more transmit parameters, from one or more predefined transmission signals.

11. The method of claim 10, wherein each of the one or more predefined transmission signals is capable of being decoded without frequency demodulation at a receiver.

12. The method of claim 10, further comprising:
transmitting, via the primary transceiver, to the network node and prior to reception of the configuration, a capability message that indicates a secondary transceiver capability, a channel state information (CSI) report capability associated with the secondary transceiver, an UL reference signal capability associated with the secondary transceiver, a low-power (LP) scheduling request capability associated with the secondary transceiver, an LP buffer status report capability associated with the secondary transceiver, or a combination thereof,
wherein the CSI report capability indicates a reference signal received power (RSRP) resolution supported by the UE, a number of resource blocks associated with a CSI report message, a number of symbols associated with the CSI report message, or a combination thereof,
wherein the UL reference signal capability indicates a reference signal bandwidth supported by the UE, a reference signal subcarrier spacing supported by the UE, a maximum number of reference signal configurations supported by the UE, a transmitter type associated with the UE, or a combination thereof, or
wherein the LP scheduling request capability or the LP buffer status report capability indicates a time period between consecutive UL transmissions via the secondary transceiver, a delay period after transmission of a WUS, or a combination thereof.

13. The method of claim 10, wherein:
the UL transmission signal indicates a channel state information (CSI) report message; and
the one or more transmit parameters include a CSI resource configuration identifier (ID) associated with the CSI report message, one or more wireless resources associated with the CSI report message, a periodicity associated with the CSI report message, a report quantity associated with the CSI report message, or a combination thereof.

14. The method of claim 13, further comprising:
monitoring, via the secondary transceiver, one or more wireless channels for one or more CSI reference signals (CSI-RSs) from the network node, the one or more CSI-RSs associated with one or more indicators, wherein the one or more indicators include one or more CSI-RS resource indicators or one or more synchronization signal block (SSB) resource indicators, and
wherein the CSI report message includes the one or more indicators and one or more respective reference signal received power (RSRP) values in accordance with the one or more CSI reference signals.

15. The method of claim 10, wherein:
the UL transmission signal is a UL reference signal; and
the one or more transmit parameters include a bandwidth associated with the UL reference signal, a subcarrier spacing associated with the UL reference signal, a transmission frequency associated with the UL reference signal, a transmitter type, a reference signal type associated with the UL reference signal, or a combination thereof.

16. The method of claim 10, wherein the UL transmission signal indicates a low-power (LP) scheduling request or an LP buffer status report, and wherein the method further comprises:
monitoring, via the secondary transceiver, one or more wireless channels for a WUS during the WUS monitoring period;
receiving the WUS during the monitoring period;
transitioning the primary transceiver from a powered-down mode to an active mode responsive to the WUS; and
monitoring, via the primary transceiver, the one or more wireless channels for an uplink grant message included in a physical downlink control channel (PDCCH) from the network node.

17. The method of claim 10, wherein the UL transmission signal indicates a low-power (LP) scheduling request, and wherein the method further comprises:
transmitting, via the secondary transceiver, to the network node and during the WUS monitoring period, another UL transmission signal that indicates the LP scheduling request;
transitioning the primary transceiver from a powered-down mode to an active mode in accordance with a count of consecutive UL transmission signals that indicate scheduling requests satisfying a threshold number of signals; and
transmitting, via the primary transceiver, to the network node, the UL transmission signal after transitioning to the active mode.

18. The method of claim 10, further comprising:
receiving, from the network node via the secondary transceiver, a downlink (DL) control signal during the WUS monitoring period, wherein the DL control signal indicates one or more updated values of the one or more transmit parameters, an instruction to send the UL transmission signal, or a combination thereof.

19. A network node for wireless communication, comprising:
a processing system that includes one or more processors and one or more memories that store code and are coupled with the one or more processors, the processing system configured to cause the network node to:
transmit, to a user equipment (UE) that includes a primary transceiver and a secondary transceiver, a configuration associated with the secondary transceiver of the UE, the configuration indicating one or more transmit parameters associated with the secondary transceiver and a wake-up signal (WUS) monitoring period; and
receive, from the UE and during the WUS monitoring period, an uplink (UL) transmission signal in accordance with the one or more transmit parameters, the UL transmission signal included in one or more predefined transmission signals.

20. The network node of claim 19, wherein the processing system is further configured to cause the network node to:
determine one or more downlink (DL) transmit parameters in accordance with the UL transmission signal; and
transmit, to the UE and in accordance with the one or more DL transmit parameters, a WUS during the WUS monitoring period.

21. The network node of claim 19, wherein the processing system is further configured to cause the network node to:
receive, from the UE and prior to transmission of the configuration, a capability message that indicates a secondary transceiver capability, a channel state information (CSI) report capability associated with the secondary transceiver, an UL reference signal capability associated with the secondary transceiver, a low-power (LP) scheduling request capability associated with the secondary transceiver, an LP buffer status report capability associated with the secondary transceiver, or a combination thereof,
wherein the CSI report capability indicates a reference signal received power (RSRP) resolution supported by the UE, a number of resource blocks associated with a CSI report message, a number of symbols associated with the CSI report message, or a combination thereof,
wherein the UL reference signal capability indicates a reference signal bandwidth supported by the UE, a reference signal subcarrier spacing supported by the UE, a maximum number of reference signal configurations supported by the UE, a transmitter type associated with the UE, or a combination thereof, or
wherein the LP scheduling request capability or the LP buffer status report capability indicates a time period between consecutive UL transmissions via the secondary transceiver, a delay period after transmission of a WUS, or a combination thereof.

22. The network node of claim 19, wherein:
the UL transmission signal indicates a channel state information (CSI) report message;
the one or more transmit parameters include a CSI resource configuration identifier (ID) associated with the CSI report message, one or more wireless resources associated with the CSI report message, a periodicity associated with the CSI report message, a report quantity associated with the CSI report message, or a combination thereof; and
the CSI report message includes one or more reference signal received power (RSRP) values associated with one or more CSI-RS resource indicators or one or more synchronization signal block (SSB) resource indicators.

23. The network node of claim 19, wherein:
the UL transmission signal includes a UL reference signal; and
the one or more transmit parameters include a bandwidth associated with the UL reference signal, a subcarrier spacing associated with the UL reference signal, a transmission frequency associated with the UL reference signal, a transmitter type, a reference signal type associated with the UL reference signal, or a combination thereof.

24. The network node of claim 19, wherein:
the UL transmission signal indicates a low-power (LP) scheduling request or an LP buffer status report; and
the processing system is further configured to cause the network node to:
transmit, to the UE and in accordance with receipt of the LP scheduling request or the LP buffer status report, a WUS during the WUS monitoring period; and
transmit, to the UE, an uplink grant message included in a physical downlink control channel (PDCCH).

25. A method of wireless communication by a network node, comprising:
transmitting, to a user equipment (UE) a primary transceiver and a secondary transceiver, a configuration associated with the secondary transceiver of the UE, the configuration indicating one or more transmit parameters associated with the secondary transceiver and a wake-up signal (WUS) monitoring period; and
receiving, from the UE and during the WUS monitoring period, an uplink (UL) transmission signal in accordance with the one or more transmit parameters, the UL transmission signal included in one or more predefined transmission signals.

26. The method of claim 25, further comprising:
determining one or more downlink (DL) transmit parameters in accordance with the UL transmission signal; and
transmitting, to the UE and in accordance with the one or more DL transmit parameters, a WUS during the WUS monitoring period.

27. The method of claim 25, further comprising:
receiving, from the UE and prior to transmission of the configuration, a capability message that indicates a secondary transceiver capability, a channel state information (CSI) report capability associated with the secondary transceiver, an UL reference signal capability associated with the secondary transceiver, a low-power (LP) scheduling request capability associated with the secondary transceiver, an LP buffer status report capability associated with the secondary transceiver, or a combination thereof,
wherein the CSI report capability indicates a reference signal received power (RSRP) resolution supported by the UE, a number of resource blocks associated with a CSI report message, a number of symbols associated with the CSI report message, or a combination thereof,
wherein the UL reference signal capability indicates a reference signal bandwidth supported by the UE, a reference signal subcarrier spacing supported by the UE, a maximum number of reference signal configurations supported by the UE, a transmitter type associated with the UE, or a combination thereof, or
wherein the LP scheduling request capability or the LP buffer status report capability indicates a time period between consecutive UL transmissions via the secondary transceiver, a delay period after transmission of a WUS, or a combination thereof.

28. The method of claim 25, wherein:
the UL transmission signal indicates a channel state information (CSI) report message;
the one or more transmit parameters include a CSI resource configuration identifier (ID) associated with the CSI report message, one or more wireless resources associated with the CSI report message, a periodicity associated with the CSI report message, a report quantity associated with the CSI report message, or a combination thereof; and
the CSI report message includes one or more reference signal received power (RSRP) values associated with one or more CSI-RS resource indicators or one or more synchronization signal block (SSB) resource indicators.

29. The method of claim 25, wherein:
the UL transmission signal includes a UL reference signal; and
the one or more transmit parameters include a bandwidth associated with the UL reference signal, a subcarrier spacing associated with the UL reference signal, a transmission frequency associated with the UL reference signal, a transmitter type, a reference signal type associated with the UL reference signal, or a combination thereof.

30. The method of claim 25, wherein the UL transmission signal indicates a low-power (LP) scheduling request or an LP buffer status report, and wherein the method further comprises:
transmitting, to the UE and in accordance with receipt of the LP scheduling request or the LP buffer status report, a WUS during the WUS monitoring period; and
transmitting, to the UE, an uplink grant message included in a physical downlink control channel (PDCCH).
